(19) United States
(12) Patent Application Publication
(10) Pub. No.: US 2025/0359600 A1
(43) Pub. Date: Nov. 27, 2025

(54) AEROSOL GENERATING DEVICE

(71) Applicant: KT&G CORPORATION, Daejeon (KR)

(72) Inventors: Jae Min Lee, Siheung-si (KR); Sang Kyu Park, Seoul (KR); Se Hwan Jung, Anyang-si (KR)

(73) Assignee: KT&G CORPORATION, Daejeon (KR)

(21) Appl. No.: 19/205,013

(22) Filed: May 12, 2025

(30) Foreign Application Priority Data
May 22, 2024 (KR) 10-2024-0066707

(51) Int. Cl. A24F 40/53; A24F 40/51; G05B 15/02; H05B 6/10

(52) U.S. Cl. CPC A24F 40/53; A24F 40/51; G05B 15/02; H05B 6/108

(57) ABSTRACT

An aerosol generating device includes a body including an insertion space to accommodate an aerosol generating article, a heater configured to heat the aerosol generating article accommodated in the insertion space, an inductive sensor configured to generate a sensing value according to a distance to a magnetic object, and a controller electrically connected to the inductive sensor and configured to determine a degree of proximity of the magnetic object to the body by comparing the sensing value with a reference value as a reference for determination, wherein the controller is further configured to calibrate the reference value based on the sensing value such that the reference value maintains a certain difference from the sensing value.

### CROSS-REFERENCE TO RELATED APPLICATION

This application is based on and claims priority under 35 U.S.C. § 119 to Korean Patent Application No. 10-2024-0066707, filed on May 22, 2024, in the Korean Intellectual Property Office, the disclosure of which is incorporated by reference herein in its entirety.

### BACKGROUND

### 1. Field

The disclosure relates to an aerosol generating device, and more particularly, to an aerosol generating device capable of precise sensing through an inductive sensor.

### 2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted.

An aerosol generating device may be equipped with an additional function to enhance user convenience. For example, an aerosol generating device may be equipped with a function of detecting whether or not a cap is coupled to the aerosol generating device or a function of detecting whether or not a cigarette is inserted into the aerosol generating device.

### SUMMARY

An inductive sensor may be arranged in an aerosol generating device. The inductive sensor may generate a signal according to a distance to a magnetic object. Accordingly, the inductive sensor may be used to detect whether a certain object including a magnetic object approaches the inductive sensor. For example, the inductive sensor may be used to detect whether or not a cap is coupled to the aerosol generating device or to detect whether or not a cigarette is inserted into the aerosol generating device.

The signal generated by the inductive sensor may correspond to a sensing value (or a sensing level) of the inductive sensor. A controller may determine, based on the sensing value, whether or not the magnetic object approaches the inductive sensor, and may further determine how proximately the magnetic object approaches the inductive sensor. Here, the controller may perform the determination only based on the sensing value or based on the degree of change of the sensing value. Also, the controller may perform the determination based on the result of comparing a previously set reference value (or reference level) with the sensing value of the inductive sensor.

For performing the determination, the controller may refer to a look-up table stored in a memory. In the memory, information about a sensing value and/or a reference value may be stored, and information related to a certain event (e.g., cigarette insertion or cap separation) corresponding to the sensing value and/or the reference value may be stored together.

The sensing vale of the inductive sensor may be influenced by the surrounding environment. For example, the sensing value may change according to the surrounding temperature or humidity. Also, when a certain magnetic object approaches the aerosol generating device, the sensing value may change. These cases correspond to a case where the sensing value changes regardless of user's intention.

In this case, because the sensing value changes, there may be a problem of not being able to determine that a certain event has occurred, although the corresponding event has occurred. Also, on the contrary, there may be a problem of determining that a certain event has occurred, although the corresponding event has not occurred.

To solve the problems described above, there is a need to calibrate the changing sensing value. In order to calibrate the sensing value, an initial value (or an initial level) to be compared with the sensing value is required. When the sensing value is calibrated according to the initial value in a natural state, the problems described above may be solved.

When the controller determines whether or not a certain event has occurred, based on the difference between a reference value and the sensing value, the problems described above may be solved by calibrating the reference value according to the changing sensing value.

Provided is an aerosol generating device which may calibrate a sensing value of an inductive sensor, based on an initial value in a natural state, or calibrate a reference value, based on the sensing value, according to embodiments.

The technical problems of the present disclosure are not limited to the above-described description, and other technical problems may be clearly understood by one of ordinary skill in the art from the embodiments to be described hereinafter.

Additional aspects will be set forth in part in the description which follows and, in part, will be apparent from the description, or may be learned by practice of the presented embodiments of the disclosure.

According to an embodiment, an aerosol generating device includes a body including an insertion space to accommodate an aerosol generating article, a heater configured to heat the aerosol generating article accommodated in the insertion space, an inductive sensor configured to generate a sensing value according to a distance to a magnetic object, and a controller electrically connected to the inductive sensor and configured to determine a degree of proximity of the magnetic object to the body by comparing the sensing value with a reference value as a reference for determination, wherein the controller is further configured to calibrate the reference value based on the sensing value such that the reference value maintains a certain difference from the sensing value.

According to another embodiment, an aerosol generating device includes a body including an insertion space to accommodate an aerosol generating article, a heater configured to heat the aerosol generating article accommodated in the insertion space, an inductive sensor configured to generate a sensing value according to a distance to a magnetic object, and a controller electrically connected to the inductive sensor and configured to determine a degree of proximity of the magnetic object to the body based on the sensing value, wherein the controller is further configured to calibrate the sensing value to become equal to a preset initial value.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A to 1C illustrate an aerosol generating device according to various embodiments;

FIGS. 2A and 2B illustrate an aerosol generating device according to other embodiments;

FIGS. 3A and 3B illustrate an aerosol generating device according to other embodiments;

FIG. 4 is a perspective view of an aerosol generating device according to an embodiment;

FIG. 5A is an exploded cross-sectional view of a cap and a body of an aerosol generating device according to an embodiment;

FIG. 5B is a cross-sectional view in which the cap and the body of the aerosol generating device illustrated in FIG. 5A are coupled to each other;

FIG. 6 is a cross-sectional view of a cap and a body of an aerosol generating device according to another embodiment, the cap and the body being coupled to each other;

FIGS. 7A and 7B are each a view showing an ideal change of a sensing value;

FIGS. 8A and 8B are each a view showing an actual change of a sensing value;

FIG. 9A is a view showing a result of calibrating a sensing value based on an initial value in the condition of FIG. 8A;

FIG. 9B is a view showing a result of calibrating a reference value based on a sensing value in the condition of FIG. 8B;

FIG. 10 is a view showing an example of calibrating a sensing value according to a certain cycle in a condition in which the sensing value cyclically changes;

FIGS. 11A to 11C are each a view showing an example of calibrating a reference value according to a certain cycle in a condition in which the sensing value cyclically changes;

FIG. 12A is a view showing an example of calibrating a sensing value according to a certain cycle in a condition in which a magnetic object approaches and then draws away from an inductive sensor;

FIG. 12B is a view showing an example of calibrating a reference value according to a certain cycle in a condition in which a magnetic object approaches and then draws away from an inductive sensor;

FIG. 13A is a view showing an example of calibrating a sensing value after a certain time period passes after a heater starts heating;

FIG. 13B is a view showing an example of calibrating a reference value after a certain time period passes after a heater starts heating;

FIG. 14A is a view showing an example of calibrating a sensing value according to a certain cycle, whereby, after a heater starts heating, the sensing value is calibrated according to the certain cycle again after a certain time period passes;

FIG. 14B is a view showing an example of calibrating a reference value according to a certain cycle, whereby, after a heater starts heating, the reference value is calibrated according to the certain cycle again after a certain time period passes;

FIG. 15A is a view showing an example of calibrating a sensing value according to a certain cycle, whereby, after an aerosol generating article is inserted, the sensing value is calibrated according to the certain cycle again, when the aerosol generating article is removed;

FIG. 15B is a view showing an example of calibrating a reference value according to a certain cycle, whereby, after an aerosol generating article is inserted, the reference value is calibrated according to the certain cycle again, when the aerosol generating article is removed;

FIG. 16A is a view showing an example of calibrating a sensing value, when a condition in which a magnetic object is approached and then distanced apart, occurs, in the condition of FIG. 15A;

FIG. 16B is a view showing an example of calibrating a reference value, when a condition in which a magnetic object is approached and then distanced apart, occurs, in the condition of FIG. 15B; and

FIG. 17 is a block diagram of an aerosol generating device according to other embodiment of the present disclosure.

### DETAILED DESCRIPTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In the description of embodiments of the disclosure, certain detailed explanations of the related art are omitted when it is deemed that they may unnecessarily obscure the essences of embodiments of the disclosure. In addition, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

While such terms as “first”, “second”, etc., may be used to describe various components, such components must not be limited to the above terms. The above terms are used only to distinguish one component from another.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

An expression used in the singular encompasses the expression of the plural, unless it has a clearly different meaning in the context.

Hereinafter, the present disclosure will now be described more fully with reference to the accompanying drawings, in which exemplary embodiments of the present disclosure are shown such that one of ordinary skill in the art may easily work the present disclosure. The same or similar components will be assigned the same reference numerals regardless of the reference numerals in the drawings, and the same descriptions thereof will be omitted.

The disclosure may, however, be embodied in many different forms and should not be construed as being limited to the embodiments set forth herein.

Hereinafter, embodiments of the disclosure will be described in detail with reference to the drawings.

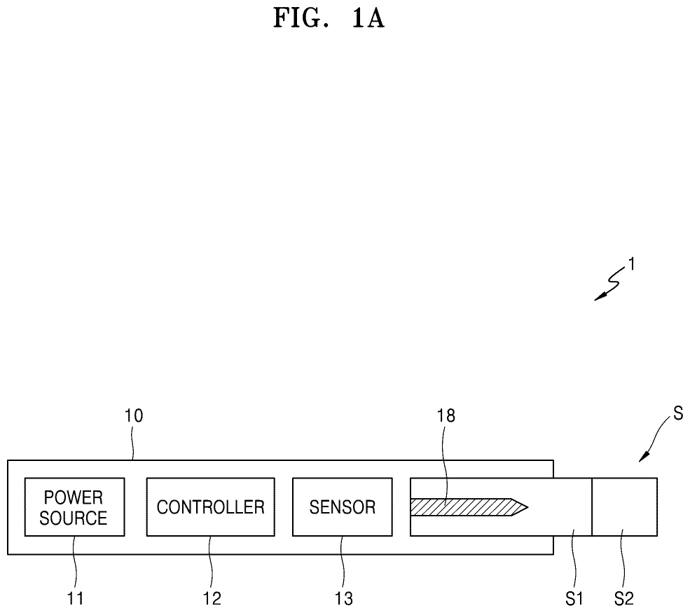

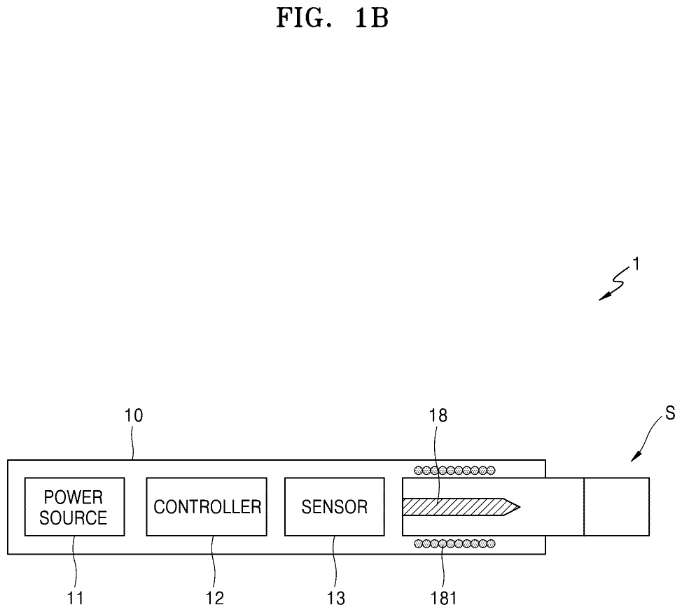

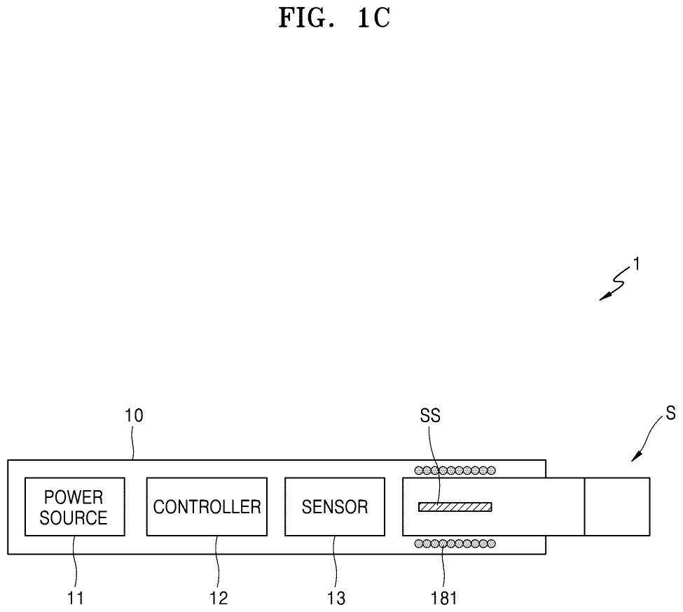

FIGS. 1A to 1C illustrate an aerosol generating device, according to various embodiments.

Referring to FIG. 1A, an aerosol generating device 1 according to embodiments may include at least one of a power source 11, a controller 12, a sensor 13, and a heater 18. At least one of the power source 11, the controller 12, the sensor 13, and the heater 18 may be disposed inside a body 10 of the aerosol generating device 1.

The body 10 may provide a space that is open upward so that a stick S, which is an aerosol generating article, is inserted. The space that is open upward may be referred to as an insertion space. The insertion space may be recessed by a certain depth toward the inside of the body 10 so that at least a part of the stick S is inserted into the insertion space. A depth of the insertion space may correspond to a length of a portion of the stick S in which an aerosol generating material and/or medium is included.

A lower end of the stick S may be inserted into the body 10, and an upper end of the stick S may protrude outward from the body 10. A user may inhale air while holding the upper end of the stick S exposed to the outside in his/her mouth.

The heater 18 may heat the stick S. The heater 18 may extend long upward, in the space into which the stick S is inserted. For example, the heater 18 may include a tube-type heating element, a plate-type heating element, a needle-type heating element, or a rod-type heating element. The heater 18 may be inserted into a lower portion of the stick S. The heater 18 may include an electro-resistive heater and/or an induction heater.

For example, referring to FIG. 1A, the heater 18 may be a resistive heater. For example, an electrically conductive track may be included in the heater 18, and the heater 18 may be heated as current flows through the electrically conductive track. The heater 18 may be electrically connected to the power source 11. The heater 18 may directly generate heat by receiving current from the power source 11.

For example, the heater 18 may be a multi-heater. The heater 18 may include a first heater and a second heater. The first and second heaters may be arranged side by side along a longitudinal direction. The first and second heaters may be heated sequentially or simultaneously.

For example, referring to FIG. 1B, the aerosol generating device 1 may include an induction coil 181 surrounding the heater 18. The induction coil 181 may cause the heater 18 to generate heat. The heater 18 is a susceptor and may generate heat due to a magnetic field generated by alternating current (AC) current flowing through the induction coil 181. The magnetic field may pass through the heater 18 to generate eddy current in the heater 18. The current may cause the heater 18 to generate heat.

For example, referring to FIG. 1C, a susceptor SS may be included inside the stick S, and the susceptor SS inside the stick S may generate heat due to a magnetic field generated by AC current flowing through the induction coil 181. The susceptor SS may be disposed inside the stick S and may not be electrically connected to the aerosol generating device 1. The susceptor SS may be inserted into the insertion space together with the stick S and may be separated from the insertion space together with the stick S. The stick S may be heated by the susceptor S inside the stick S. In this case, the heater 18 may not be provided in the aerosol generating device 1.

The power source 11 may supply power so that components of the aerosol generating device 1 operate. The power source 11 may be referred to as a battery. The power source 11 may supply power to at least one of the controller 12, the sensor 13, and the heater 18. When the aerosol generating device 1 includes the induction coil 181, the power source 11 may supply power to the induction coil 181.

The controller 12 may control an overall operation of the aerosol generating device 1. The controller may be mounted on a printed circuit board (PCB). The controller 12 may control an operation of at least one of the power source 11, the sensor 13, and the heater 18. The controller 12 may control an operation of the induction coil 181. The controller 12 may control operations of a display, a motor, etc. provided in the aerosol generating device 1. The controller 12 may check a state of each component of the aerosol generating device 1 to determine whether the aerosol generating device 1 is operable.

The controller 12 may analyze a result detected by the sensor 13 and may control processes to be performed later. For example, the controller 12 may control power supplied to the heater 18 so that an operation of the heater 18 starts or ends, based on the result detected by the sensor 13. For example, the controller 12 may control the amount or time of power supplied to the heater 18 so that the heater 18 is heated to a certain temperature or is maintained at an appropriate temperature, based on the result detected by the sensor 13.

The sensor 13 may include at least one of a temperature sensor, a puff sensor, an insertion detection sensor, and an acceleration sensor. For example, the sensor 13 may sense at least one of a temperature of the heater 18, a temperature of the power source 11, and a temperature inside and outside the body 10. For example, the sensor 13 may sense the user's puff. For example, the sensor 13 may sense whether the stick S is inserted into the insertion space. For example, the sensor 13 may sense a movement of the aerosol generating device 1.

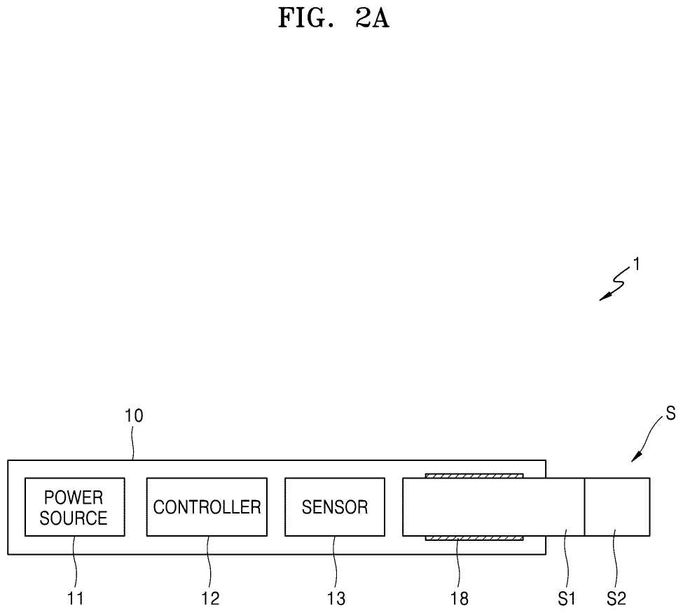

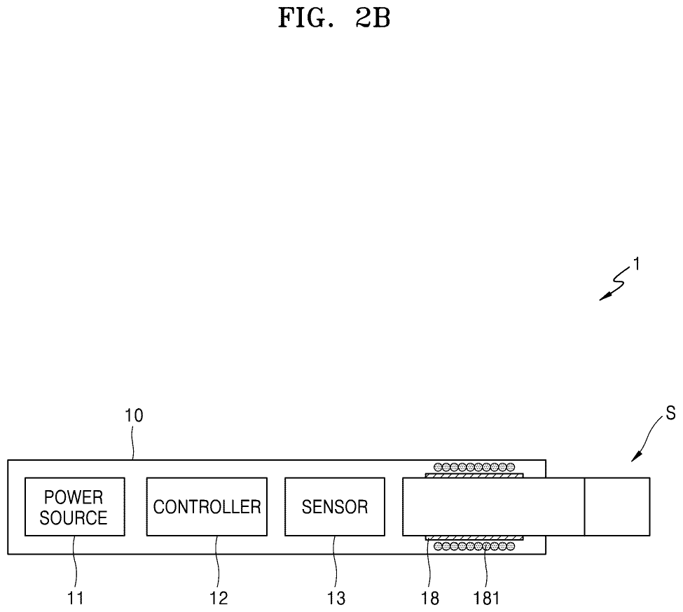

FIGS. 2A and 2B illustrate an aerosol generating device, according to other embodiments.

At least one of components of the aerosol generating device 1 of FIGS. 2A and 2B may be the same as or similar to at least one of components of the aerosol generating device 1 of FIGS. 1A to 1C, and thus, a repeated description will be omitted.

Referring to FIG. 2A, the heater 18 may extend long upward around a space into which the stick S is inserted. For example, the heater 18 may have a tube shape including a hollow portion therein. The heater 18 may be disposed around the insertion space. The heater 18 may surround at least a part of the insertion space. The heater 18 may heat the insertion space or the outside of the stick S inserted into the insertion space. The heater 18 may include an electro-resistive heater and/or an induction heater.

Referring to FIG. 2B, the aerosol generating device 1 may include the induction coil 181 surrounding the heater 18. The induction coil 181 is the same as that described above, and thus, a repeated description thereof will be omitted.

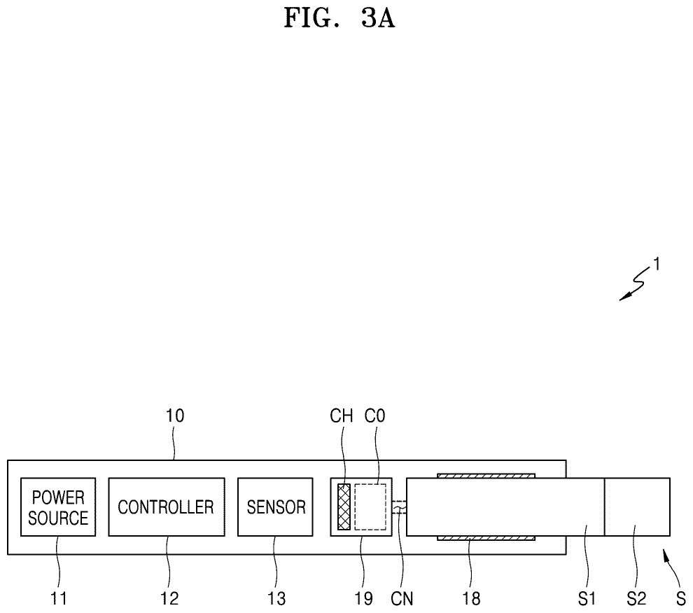

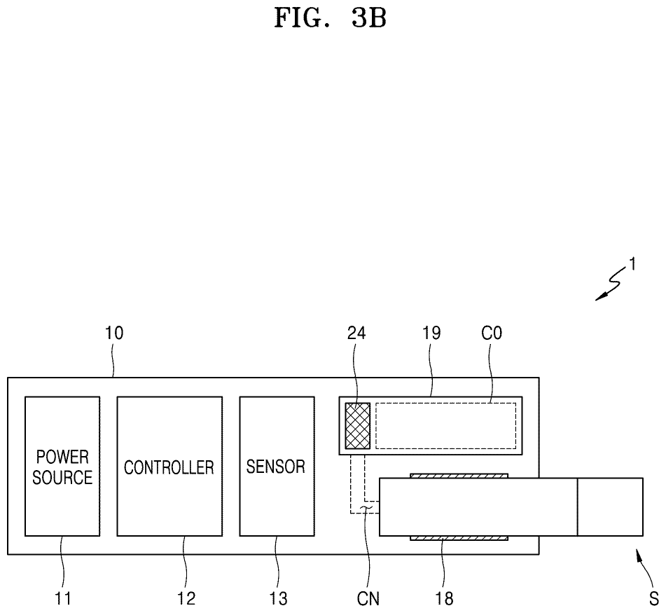

FIGS. 3A and 3B illustrate an aerosol generating device, according to other embodiments.

At least one of components of the aerosol generating device 1 of FIGS. 3A and 3B may be the same as or similar to at least one of components of the aerosol generating device 1 of FIGS. 1A to 1C, and thus, a repeated description will be omitted.

Referring to FIG. 3A, the aerosol generating device 1 may further include a cartridge 19.

The cartridge 19 may contain an aerosol generating material in a liquid state, a solid state, or a gel state. The aerosol generating material may include a liquid composition. For example, the liquid composition may be a liquid including a tobacco-containing material including a volatile tobacco flavor component, or a liquid including a non-tobacco material.

For example, the liquid composition may include water, solvents, ethanol, plant extracts, spices, flavorings, or vitamin mixtures. The spices may include menthol, peppermint, spearmint oil, and various fruit-flavored ingredients, but are not limited thereto. The flavorings may include ingredients capable of providing various flavors or tastes to the user. The vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The cartridge 19 may be integrally formed with the body 10 or may be detachably coupled to the body 10. For example, the cartridge 19 may be mounted on the body 10 by being inserted into the body 10. However, the disclosure is not limited thereto, and the cartridge 19 may be fixed so as not to be removed by the user.

The cartridge may be mounted on the body in a state where the aerosol generating material is accommodated in the cartridge. However, the disclosure is not limited thereto, and the aerosol generating material may be injected into the cartridge in a state where the cartridge is coupled to the body.

Referring to FIG. 3A, the cartridge 19 may be integrally formed with the body 10, and may communicate with the insertion space through an airflow channel CN.

Referring to FIG. 3B, a space may be formed on one side in the body 10, and the cartridge 19 may be mounted on the body 10 when at least a part of the cartridge 19 is inserted into the space formed on one side in the body 10. The airflow channel CN may be defined by a part of the cartridge and/or a part of the body 10, and the cartridge 19 may communicate with the insertion space through the airflow channel CN.

Components of the aerosol generating device 1 of FIG. 3A are aligned. In the aerosol generating device 1 of FIG. 3B, the cartridge 19 and the heater 18 are arranged parallel to each other. However, an internal structure of the aerosol generating device 1 is not limited thereto. In other words, according to a design of the aerosol generating device 1, the arrangement of the power source 11, the controller 12, the sensor 13, the heater 18, and the cartridge 19 may be changed.

The body 10 may have a structure that external air may be introduced into the body 10 in a state where the cartridge 19 is inserted. In this case, the external air introduced into the body 10 may pass through the cartridge 19 and may flow to the user's mouth.

The cartridge 19 may include a storage CO containing an aerosol generating material and/or a heater 24 configured to heat the aerosol generating material of the storage CO. A liquid transfer means in which the aerosol generating material is impregnated (contained) may be disposed inside the storage CO. The liquid transfer means may include a wick such as cotton fiber, ceramic fiber, glass fiber, or porous fiber. An electrically conductive track of the heater 24 may have a coil structure that is wound around the liquid transfer means or a structure that contacts one side of the liquid transfer means. The heater 24 may be referred to as a cartridge heater 24.

The cartridge 19 may generate aerosol by converting a phase of the aerosol generating material inside the cartridge into a gas phase, by operating by an electrical signal or a wireless signal transmitted from the body 10. In this case, the aerosol may refer to gas in which vaporized particles generated from the aerosol generating material and air are mixed.

Aerosol may be generated as the liquid transfer means and the liquid composition absorbed by the liquid transfer means are heated by the cartridge heater 24. In this case, aerosol may also be generated by heating the stick S using the heater 18. While aerosol generated by the cartridge heater 24 and the heater 18 passes through the stick S, a tobacco material may be added to the aerosol, and the aerosol to which the tobacco material is added may be inhaled into the user's mouth through one end of the stick S.

The aerosol generating device 1 may include only the cartridge heater 24 and the heater 18 may not be provided in the body 10. In this case, while aerosol generated by the cartridge heater 24 passes through the stick S, a tobacco material may be added and the aerosol to which the tobacco material is added may be inhaled into the user's mouth.

The aerosol generating device 1 may include a cap (not shown). The cap may be detachably coupled to the body 10 to cover at least a part of the cartridge 19 coupled to the body 10. The stick S may be inserted into the body 10 through the cap.

The power source 11 may supply power to the cartridge 24 in addition to the above-described components. The controller 12 may control an operation of the cartridge 19 in addition to the above-described components. The controller 12 may control power supplied to the cartridge heater 24 so that an operation of the cartridge heater 24 and/or the heater 18 starts or ends, based on a result detected by the sensor 13. For example, the controller 12 may control the amount and time of power supplied to the cartridge heater 24 so that the cartridge heater 24 is heated to a certain temperature or is maintained at an appropriate temperature, based on the result detected by the sensor 13.

The sensor 13 may further include at least one of a color sensor, a cartridge detection sensor, and a cap detection sensor in addition to the above-described components. For example, the sensor 13 may sense a temperature of the cartridge heater 24. For example, the sensor 13 may sense a color of a part of a wrapper surrounding an outer surface of the stick S. For example, the sensor 13 may sense whether the cartridge 19 is mounted. For example, the sensor 13 may sense whether the cap is mounted.

The aerosol generating device 1 may further include general-purpose components in addition to the power source 11, the controller 12, the sensor 13, the heater 18, and the cartridge 19. For example, as described above, the aerosol generating device 1 may include a display capable of outputting visual information and/or a motor for outputting haptic information. Also, the aerosol generating device 1 may be manufactured in a structure in which external air may be introduced or internal gas may be discharged even in a state where the stick S is inserted.

Although not shown, the aerosol generating device 1 may constitute a system along with a separate cradle. For example, the cradle may be used to charge the power source 11 of the aerosol generating device 1. Alternatively, the heater 18 may be heated in a state where the cradle and the aerosol generating device 1 are coupled to each other.

The stick S may be similar to a general combustion-type cigarette. For example, the stick S may be divided into a first portion S1 including an aerosol generating material and a second portion S2 including a filter, etc.

The first portion S1 may be made of a sheet, a strands, or a tobacco cut filler obtained by finely cutting a tobacco sheet. Also, the first portion S1 may be surrounded by a thermally conductive material. For example, the thermally conductive material may be a metal foil such as an aluminum foil, but the disclosure is not limited thereto. Hereinafter, the first portion S1 may be referred to as a ‘medium portion’ or a ‘tobacco rod’.

The second portion S2 may be a cellulose acetate filter. The second portion S2 may include at least one segment. For example, the second portion S2 may include a first segment for cooling aerosol and a second segment for filtering a certain component included in the aerosol. Hereinafter, the second portion S2 may be referred to as a ‘filter rod’.

According to an embodiment, an aerosol generating material may also be included in the second portion S2 of the stick S. For example, an aerosol generating material made in the form of granules or capsules may be inserted into the second portion S2.

The first portion S1 may be entirely inserted into the aerosol generating device 1, and the second portion S2 may be exposed to the outside. Alternatively, only a part of the first portion S1 may be inserted into the aerosol generating device 1, or the entire first portion S1 and a part of the second portion S2 may be inserted. The user may inhale aerosol while holding the second portion S2 with his/her mouth. In this case, aerosol is generated when external air passes through the first portion S1, and the generated aerosol passes through the second portion S2 and is delivered to the user's mouth.

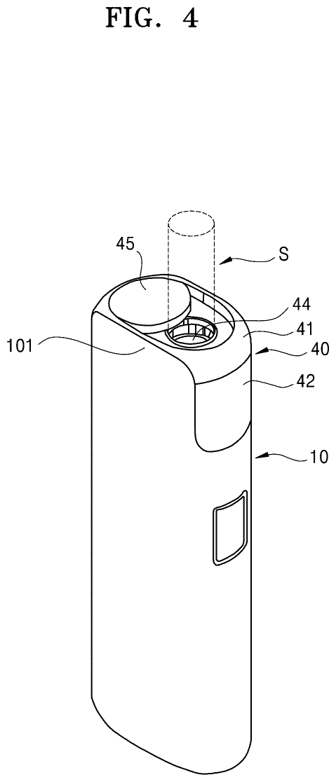

FIG. 4 is a perspective view of an aerosol generating device 1 according to an embodiment.

Referring to FIG. 4, the aerosol generating device 1 according to an embodiment may include a body 10 and a cap 40.

The body 10 may form the general exterior of the aerosol generating device 1 and may include an inner space in which components of the aerosol generating device 1 may be arranged. The shape of the body 10 is not limited to the illustrated shape. The body 10 may be generally formed to have a cylindrical shape or a polygonal pillar shape.

The body 10 may include an opening through which a stick S may be inserted into the body 10. At least a portion of the stick S may be inserted into or accommodated in the body 10 through the opening. The stick S may be used interchangeably with a cigarette or an aerosol generating article.

The body 10 may include an insertion space in which the stick S may be accommodated. The insertion space may be formed at an upper portion of the body 10. The insertion space may be open at an upper side and may be connected to the opening.

The insertion space may have a cylindrical shape extending long in upper and lower directions. At least a portion of the stick S may be accommodated in the body 10 through the opening in the upper side of the insertion space. A depth by which the stick S may be inserted into the insertion space may correspond to a length of a portion of the stick S, the portion including an aerosol generating article or substrate.

The cap 40 may be separably coupled to the body 10. The cap 40 may be coupled to an upper side of the body 10. The cap 40 may cover an area around the upper portion of the body 10. The cap 40 may include an insertion hole 44. The stick S may be inserted into the insertion hole 44. The cap 40 may include a door 45 configured to open and close the insertion hole 44. The door 45 may slide in a lateral direction and may open and close the insertion hole 44.

The cap 40 may include a cap wing 42. The cap wing 42 may extend from both sides of a cap body 41 to a lower side. The cap wing 42 may be referred to as a cap grip 42.

The body 10 may include a body wing 101. The body wing 101 may extend from an edge of the upper portion of the body 10 toward an upper side. The body wing 101 may be formed as a pair of body wings facing each other with respect to the upper portion of the body 10. The body wing 101 may be formed at a location deviating from the cap wing 42.

When the cap 40 is coupled to the body 10, the cap 40 may form the upper exterior of the aerosol generating device 1. When the cap 40 is coupled to the body 10, the body wing 101 may cover a side portion of the cap 40 exposed through the cap wing 42. When the cap 40 is coupled to the body 10, the cap wing 42 may cover an outer side wall of the body 10.

However, the shape of the cap 40 is not limited to the illustrated shape. The cap 40 may include various shapes to cover the area around the upper portion of the body 10 and to be separably coupled to the body 10.

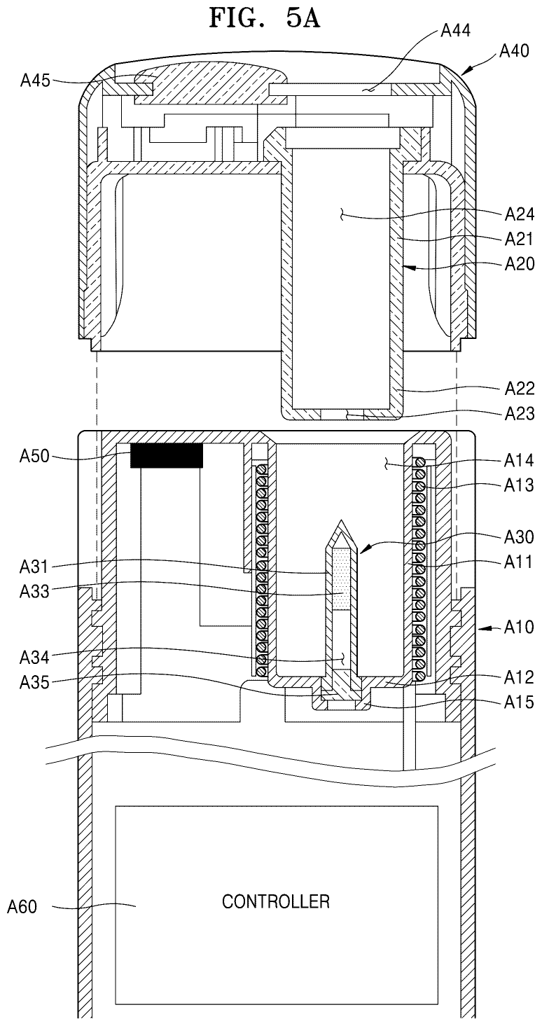

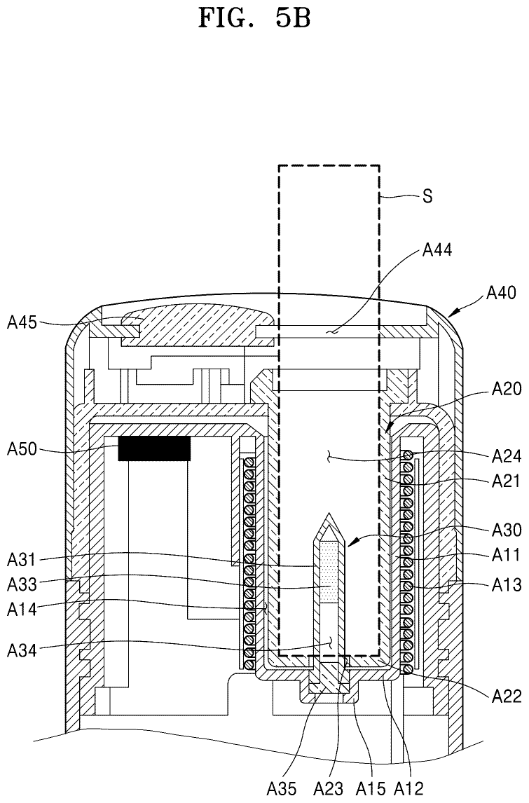

FIG. 5A is an exploded cross-sectional view of a cap and a body of an aerosol generating device according to an embodiment, and FIG. 5B is a cross-sectional view of the cap and the body of the aerosol generating device illustrated in FIG. 5A, the cap and the body being coupled to each other.

Referring to FIGS. 5A and 5B, the aerosol generating device 1 according to an embodiment may include a body A10, an extractor A20, a heater assembly A30, a cap A40, an inductive sensor A50, and a controller A60.

The body A10 may include pipes A11 and A12 forming a first insertion space A14. The first insertion space A14 may be formed at an upper portion of the body A10. The first insertion space A14 may be open toward an upper side. The first insertion space A14 may have a cylindrical shape extending long in upper and lower directions. A first side wall A11 of the pipes A11 and A12 may surround a side portion of the first insertion space A14. A first flange A12 of the pipes A11 and A12 may cover a lower portion of the first insertion space A14.

A second insertion space A24 may be provided in the extractor A20. The second insertion space A24 may be open toward an upper side of the extractor A20. The second insertion space A24 may have a cylindrical shape extending long in upper and lower directions. A second side wall A21 of the extractor A20 may surround a side portion of the second insertion space A24. A second flange A22 of the extractor A20 may cover a lower portion of the second insertion space A24. A through hole A23 may be formed as the center of the second flange A22 is open.

The extractor A20 may be inserted into the first insertion space A14. When the extractor A20 is inserted into the first insertion space A14, the second insertion space A24 may be arranged at an inner side of the first insertion space A14. The second insertion space A24 may be open toward the upper side of the body A10. The diameter of the second insertion space A24 may be less than the diameter of the first insertion space A14. The first insertion space A14 and the second insertion space A24 may be connected to each other through the through hole A23.

The heater assembly A30 may be fixed in the body A10. The heater assembly A30 may protrude long upwardly from the first flange A12 in the first insertion space A14. The heater assembly A30 may pass through the through hole A23. An upper portion of the heater assembly A30 may be arranged in the second insertion space A24 through the through hole A23. The heater assembly A30 may heat the second insertion space A24.

The heater assembly A30 may include a heater rod A31 and a heater A33. The heater rod A31 may upwardly protrude from the first flange A12 toward the first insertion space A14. The heater rod A31 may extend long in upper and lower directions. A body of the heater rod A31 may have a cylindrical shape. An upper end of the heater rod A31 may be formed to be sharp toward an upper side.

The heater A33 may be inserted into a cavity A34 of the heater rod A31. The heater A33 may be fixed in the heater rod A31. The cavity A34 may be open toward a lower side and may be filled with a heater cap A35. A heater mount A15 may be formed as the first flange A12 is recessed toward a lower side. A lower end of the heater rod A31 and the heater cap A35 may be fixed in the heater mount A15.

The heater A33 may include a resistive heater. When the heater A33 emits heat, the heat may pass through the heater rod A31 and may heat the second insertion space A24. An inductive coil A13 may make the heater A33 emit heat. The inductive coil A13 may be wound around a circumference of the first side wall A11 in upper and lower directions and may surround the first insertion space A14 and the heater A33. The heater A33 may include a susceptor, and the heater A33 may emit heat through a magnetic field generated by an alternating current (AC) flowing through the inductive coil A13. The magnetic field may pass through the heater A33 and may generate an eddy current in the heater A33. The current may generate heat in the heater A33. Alternatively, unlike what is illustrated, the heater A33 may emit heat by directly receiving power.

As illustrated, the heater A33 may be inserted into the stick S and may heat an inner portion of the stick S. However, an embodiment is not limited to the shape and the arrangement of the heater A33. As another example, the heater A33 may include a cylindrical-shaped heater surrounding at least a portion of the stick S and heating an outer circumferential surface of the stick S.

Also, the heater A33 may include a cartridge heater (e.g., the cartridge heater 24 of FIGS. 3A and 3B). In this case, an aerosol generating article S may be the cartridge 19 of FIGS. 3A and 3B, rather than a cigarette or a stick.

The cap A40 may be separably coupled to an end of the body A10. The cap A40 may cover the upper portion of the body A10 around the first insertion space A14. The extractor A20 may be coupled to the cap A40 and may integrally move with the cap A40. When the cap A40 is coupled to the body A10, the extractor A20 may be inserted into the first insertion space A14, and the heater assembly A30 may pass through the through hole A23 of the second flange A22 and may be located in the second insertion space A24.

The cap A40 may include an insertion hole A44. The insertion hole A44 may be aligned with the second insertion space A24 at an upper side of the second insertion space A24 of the extractor A20. The insertion hole A44 may have a circular-shaped lateral cross-section. A door A45 may be movably mounted on the cap A40. The door A45 may open and close the insertion hole A44 and the second insertion space A24.

The stick S may be inserted into the second insertion space A24. The stick S may be inserted into the second insertion space A24 by passing through the insertion hole A44. An upper side of the stick S may be exposed through an upper side of the extractor A20 and the cap A40. The stick S may be supported by the second side wall A21 and the second flange A22 in the second insertion space A24. The heater rod A31 passing through the cavity A34 may be inserted into a lower portion of the stick S inserted into the second insertion space A24.

At least a portion of the stick S accommodated in the second insertion space A24 may be heated by the heater A33. As the stick S is heated, vaporized particles may be generated. Here, a user may have an end of the stick S exposed to the outside in his or her mouth and may suck in air. When the user sucks in the air, the air may be introduced into an inner space of the body A10 through an air inlet formed at a portion of the body A10. The air may be introduced into the stick S through the through hole A23 and may be mixed with the vaporized particles to generate an aerosol. The aerosol may move through the stick S to be provided to the user.

The inductive sensor A50 may be configured to generate a sensing value according to a distance to a magnetic object. The inductive sensor A50 may be used to determine whether or not the cap A40 is coupled to the body A10. That is, the inductive sensor A50 may function as a cap detection sensor. The inductive sensor A50 may sense whether or not the cap A40 is mounted. The inductive sensor A50 may generate a sensing value according to a distance to the cap A40 including the magnetic object. By using the inductive sensor A50, the controller A60 may read the sensing value (inductance value) changing when the cap A40 is coupled to the body A10.

The sensing value may change according to whether or not the cap A40 is coupled to the body A10. In detail, the sensing value generated by the inductive sensor A50 may be affected by the magnetic object included in the cap A40. The sensing value may change according to the distance between the inductive sensor A50 arranged at a portion of the body 10 and the cap A40.

Here, for the inductive sensor A50 to easily detect the cap A40, the inductive sensor A50 may be arranged at the upper portion of the body A10. The inductive sensor A50 may be arranged to face the cap A40. However, the location of the inductive sensor A50 is not limited to the location illustrated in the drawing.

The inductive sensor A50 may generate the sensing value according to the distance to the cap A40, and the controller A60 may continually read the sensing value. The controller A60 electrically connected to the inductive sensor A50 may determine, based on a certain sensing value of the inductive sensor A50 or a change of the sensing value, that the cap A40 is separated from the body A10.

When the controller A60 determines that the cap A40 is separated from the body A10, the controller A60 may control a user interface to provide, to a user, a notification that the cap A40 is separated. For example, the user interface may include a display, a speaker, etc. Thus, the user may recognize that the cap A40 is not appropriately mounted on the body A10 or is separated from the body A10 and may correspondingly take measures.

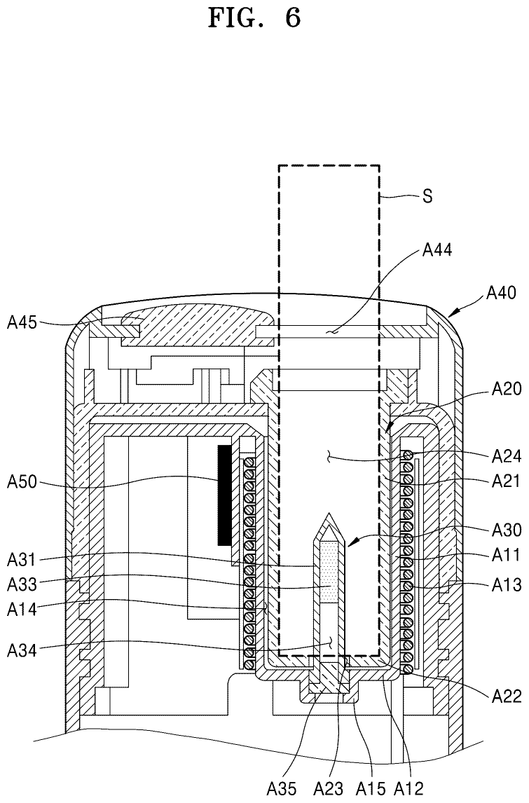

FIG. 6 is a cross-sectional view of the cap A40 and the body A10 of the aerosol generating device 1 according to another embodiment, the cap A40 and the body A10 of the aerosol generating device 1 being coupled to each other.

Referring to FIG. 6, the aerosol generating device 1 according to an embodiment may include the body A10, the extractor A20, the heater assembly A30, the cap A40, the inductive sensor A50, and the controller A60.

At least one of the components of the aerosol generating device 1 illustrated in FIG. 6 may be the same or substantially the same as at least one of the components of the aerosol generating device 1 illustrated in FIGS. 5A and 5B. Hereinafter the same descriptions are omitted.

The inductive sensor A50 may be used to determine whether or not the stick S is inserted into the first insertion space A14 or the second insertion space A24. That is, the inductive sensor A50 may function as an insertion detection sensor. The inductive sensor A50 may sense whether or not the stick S is inserted. The inductive sensor A50 may generate a sensing value according to a distance to the stick (e.g., an aerosol generating article) S including a magnetic object. The controller A60 may read, by using the inductive sensor A50, the sensing value (or inductance value) changing as the stick S is inserted into the first insertion space A14 or the second insertion space A42.

The sensing value may change according to whether or not the stick S is accommodated in the first or second insertion space A14 or A24. In detail, the sensing value generated by the inductive sensor A50 may be affected by a metal material such as aluminum or a magnetic object, included in the stick S. The sensing value may change according to the distance between the inductive sensor A50 arranged at a portion of the body A10 and the stick S.

Here, for the inductive sensor A50 to easily sense the stick S, the inductive sensor A50 may be arranged to surround the first and second insertion spaces A14 and A24. The inductive sensor A50 may be arranged at a portion (e.g., the first side wall A11 of a pipe) of the body A10 surrounding a side portion of the first insertion space A14. The inductive sensor A50 may be arranged toward the second insertion space A24.

However, the location of the inductive sensor A50 is not limited to the location illustrated in the drawing. As another example, the inductive sensor A50 may be arranged at a portion (e.g., the first flange A12 of the pipe) of the body A10 covering a lower portion of the first insertion space A14.

The inductive sensor A50 may generate the sensing value according to the distance to the stick S, and the controller A60 may continually read the sensing value. The controller A60 electrically connected to the inductive sensor A50 may determine, based on a certain sensing value of the inductive sensor A50 or a change of the sensing value, that the stick S is accommodated in the first or second insertion space A14 or A24.

When the controller A60 determines that the stick S is accommodated in the first or second insertion space A14 or A24, the controller A60 may control the heater A33 to heat an aerosol generating article for smoking. Thus, the stick S may be started to be heated just as the user inserts the stick S into the body A10 without the user manipulating the heater A33.

Hereinafter, the change of the sensing value of the inductive sensor A50 is to be described.

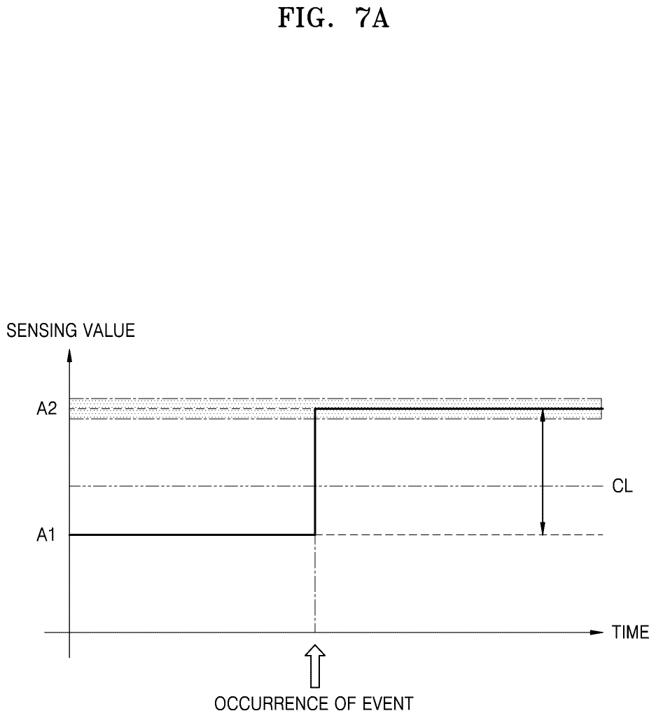

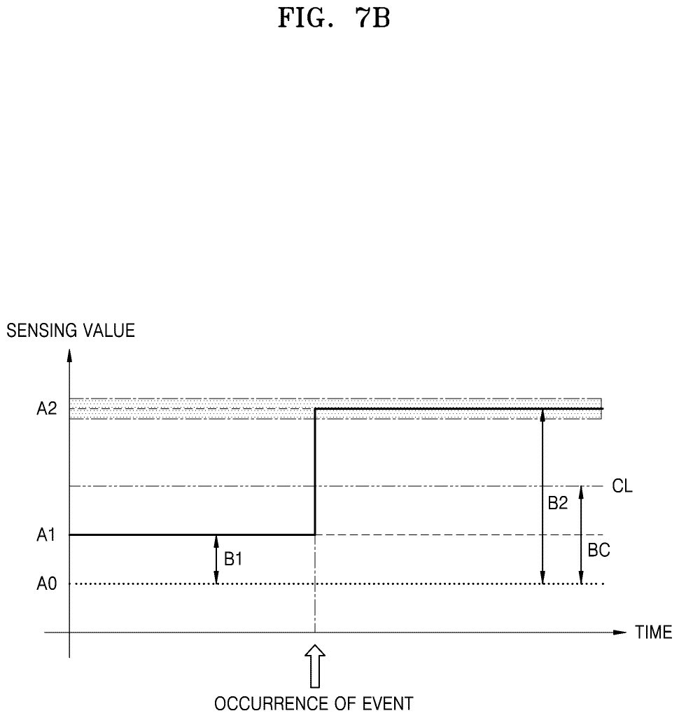

FIGS. 7A and 7B are each a view showing an ideal change of the sensing value.

Referring to FIGS. 7A and 7B, a graph with respect to a chronological change of the sensing value of an inductive sensor in an ideal condition is illustrated. The horizontal axis of the graph indicates time, and the vertical axis of the graph indicates the sensing value. Here, the sensing value may correspond to a current value, but is not necessarily limited thereto.

The inductive sensor may generate the sensing value changing according to the occurrence of a certain event (e.g., insertion of a cigarette or mounting of a cap). For example, when the inductive sensor is used as a cap detection sensor, and when an event in which the cap is separated from the body and then is mounted on the body occurs, the sensing value generated by the inductive sensor may change from A1 to A2. As another example, when the inductive sensor is used as an insertion detection sensor, and when an event in which an aerosol generating article is inserted into an insertion space occurs, the sensing value generated by the inductive sensor may change from A1 to A2.

An embodiment is not limited to the examples above. On the contrary to the description above, when an even in which the cap is separated from the body or an event in which the aerosol generating article is removed from the insertion space occurs, the sensing value may change from A1 to A2.

However, hereinafter, for convenience of explanation, the case where the sensing value changes from A1 to A2 is assumed to correspond to the case where an event in which the cap is mounted on the body or an event in which the aerosol generating article is inserted into the insertion space occurs.

A controller may determine, based on the sensing value generated by the inductive sensor, the degree by which a magnetic object is proximate to the body. Here, the determining of the degree based on the sensing value may include using only the sensing value or comparing the sensing value with a reference value, which is a reference for determination. Thus, the controller may determine, based on the sensing value, whether or not a corresponding event has occurred. There may be various methods, performed by the controller, of interpreting the sensing value, and each method may differ from each other according to an embodiment.

Referring to FIG. 7A, for example, the controller may determine that the corresponding event has occurred, when the sensing value exceeds a predetermined critical value CL.

As another example, the controller may determine that the corresponding event has occurred, when the sensing value corresponds to A2. Here, “that the sensing value corresponds to A2” may denote not only that the sensing value corresponds to a certain value of A2, but also that the sensing value falls into a certain range including A2. The certain range may be set by a user. Hereinafter, the expression of corresponding to a certain value may be used as the same meaning as described above.

As another example, the controller may determine that the corresponding event has occurred, when the sensing value changes from A1 to A2.

As another example, the controller may determine that the corresponding event has occurred, based on the degree of change, when the sensing value changes from A1 to A2. Here, the degree of change may denote the change amount or may denote the change rate, according to an embodiment.

Referring to FIG. 7B, the controller may interpret the sensing value with reference to a predetermined reference value. In this case, the controller may determine whether or not an event has occurred, based on the difference between the sensing value and the reference value. In detail, the controller may determine whether or not a cap is coupled to a body or whether or not an aerosol generating article is accommodated in an insertion space, based on the reference value and the sensing value.

Here, a difference value between the sensing value and the reference value may denote the difference between the two values or may denote the ratio between the two values. For convenience of explanation, a difference value between A1 and A0 is assumed as B1, and a difference value between A2 and A0 is assumed as B2.

For example, the controller may determine that a corresponding event has occurred, when the difference between the sensing value and the reference value exceeds BC, which is a difference value between the critical value CL and the reference value.

As another example, the controller may determine that a corresponding event has occurred, when the difference between the sensing value and the reference value corresponds to B2.

As another example, the controller may determine that a corresponding event has occurred, based on the degree of change of the difference value, when the difference between the sensing value and the reference value changes. Here, the degree of change may denote the change amount or the change rate, according to an embodiment. In detail, the controller may determine that the corresponding event has occurred, based on the degree of change from B1 to B2.

It may be noted that the sensing value generated by the inductive sensor before an event occurs may be constant as A1, and the sensing value generated by the inductive sensor after the event occurs may be constant as A2. That is, the sensing value may change only when a certain event occurs.

However, the description is based on the assumption of an ideal condition, and in a real condition, the sensing value of the inductive sensor may change due to various factors, even when a certain event has not occurred.

Hereinafter, the change of the sensing value of the inductive sensor in a real condition is to be described.

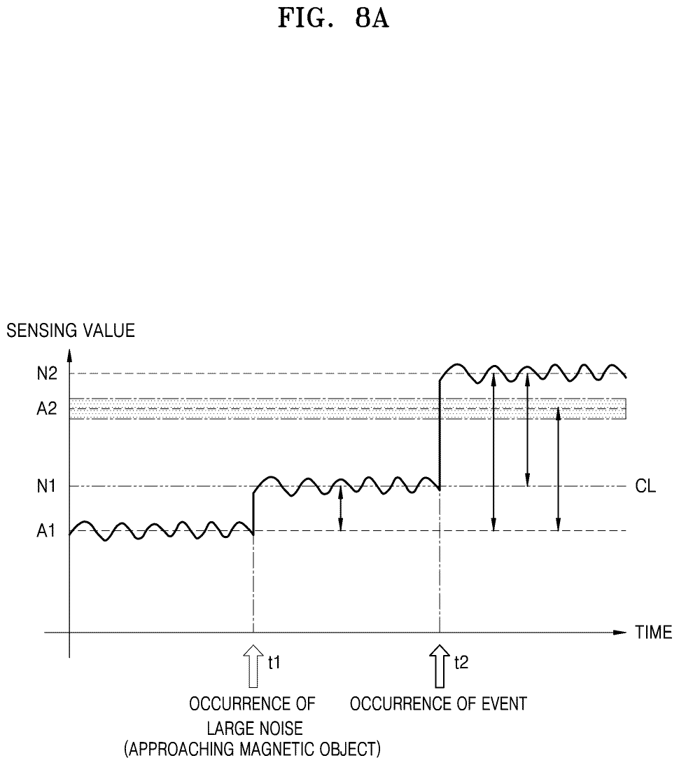

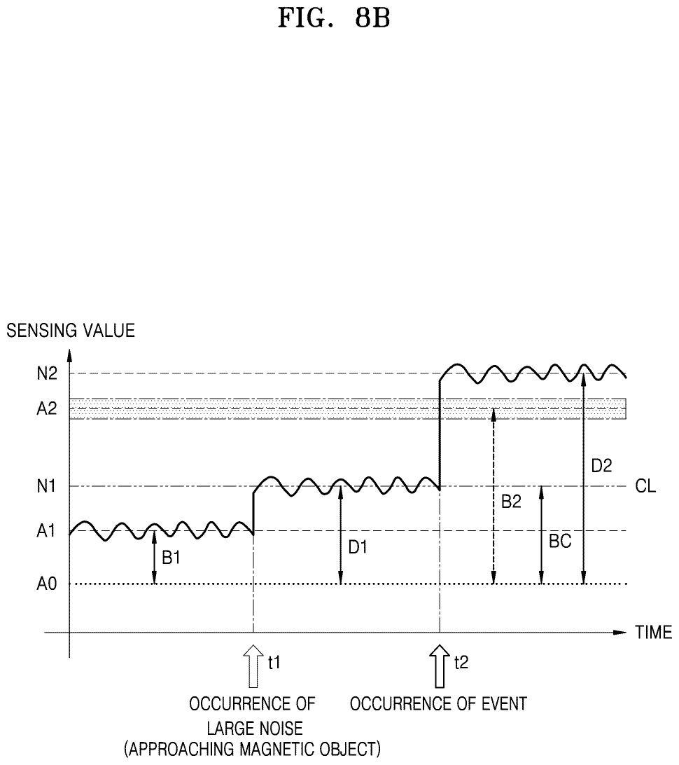

FIGS. 8A and 8B are each a view showing an actual change of the sensing value.

Referring to FIGS. 8A and 8B, a graph with respect to a chronological change of the sensing value of the inductive sensor in an actual situation is illustrated. The meaning of the axes of the graph may be the same as described above.

Unlike in the graph illustrated in FIGS. 7A and 7B, the sensing value of the inductive sensor may continually change in FIGS. 8A and 8B. In addition to the occurrence of a certain event (e.g., mounting/separation of a cap or insertion/removal of a cigarette), there may be various factors for the change of the sensing value of the inductive sensor. Here, “that a certain event has occurred” is assumed to denote that a certain event, which is the object of determination of the controller, described above, has occurred.

For example, the sensing value of the inductive sensor may be affected by the surrounding environment. For example, the sensing value may change according to the surrounding temperature or humidity. Also, the sensing value may change when a certain magnetic object approaches an aerosol generating device. Also, the sensing value may change according to a type of the magnetic object approaching. These cases correspond to a case where the sensing value changes regardless of user's intention.

As illustrated in the drawing, the sensing value fluctuating may denote that relatively small noise is generated. Then, the sensing value rising sharply at t1 may denote that large noise, such as approaching of a magnetic object, is generated. Hereinafter, unless specifically described, small noise is ignored.

Unlike FIGS. 7A and 7B in which the sensing value changes from A1 to A2, in FIGS. 8A and 8B, the sensing value, which is A1, changes to N1, with large noise being generated at t1, and changes to N2, with the occurrence of a certain event at t2.

Referring to FIG. 8A, for example, from the point at which the large noise is generated, the sensing value becomes N1 to be the same as a critical value, and thus, a controller may wrongly determine that a certain event has occurred, before the event occurs.

As another example, the sensing value becomes N1 and N2 and does not correspond to A2, and thus, the controller may wrongly determine that an event has not occurred, even though the corresponding event has occurred.

As another example, the sensing value does not change from A1 to A2 and changes to N1 and N2, and thus, the controller may wrongly determine that a certain event has not occurred, even though the event has occurred.

As another example, when the determination of the controller is based on the change amount of the sensing value, the degree of change from A1 to A2 is the same as the degree of change from N1 to N2, and thus, the controller may correctly determine that an event has occurred. However, when the determination of the controller is based on the change rate of the sensing value, the degree of change from A1 to A2 is different from the degree of change from N1 to N2, and thus, the controller may wrongly determine that a certain event has not occurred, even though the event has occurred.

Referring to FIG. 8B, for example, from the point at which the large noise is generated, D1, which is the difference between the sensing value and a reference value, becomes the same as BC, which is the difference between the critical value CL and the reference value, and thus, the controller may wrongly determine that a certain event has occurred, even before the event occurs.

As another example, the difference between the sensing value and the reference value becomes D1 and D2 and does not correspond to B2, and thus, the controller may wrongly determine that a certain event has not occurred, even though the event has occurred.

As another example, while the difference between the sensing value and the reference value changes from B1 to D1 and from D1 to D2, “the degree of change from B1 to D1” and “the degree of change from D1 to D2” may each be different from “the degree of change from B1 to B2,” and thus, the controller may wrongly determine that a certain event has not occurred, even though the event has occurred.

In summary, the sensing value may change according to the noise. Thus, with respect to a certain event, while the controller has to accurately determine whether or not the certain event has occurred, the controller may wrongly determine whether or not the certain event has occurred.

To solve the problems described above, an operation of calibrating the sensing value or the reference value is required. To calibrate the sensing value, an initial value to be compared with the sensing value is required. Here, the initial value may denote a sensing value in a natural state with no noise. When the sensing value is calibrated to be in compliance with the initial value in the natural state or the reference value is calibrated according to the changing sensing value, the problems described above may be solved.

Hereinafter, a result after the calibration is performed in the conditions above is described.

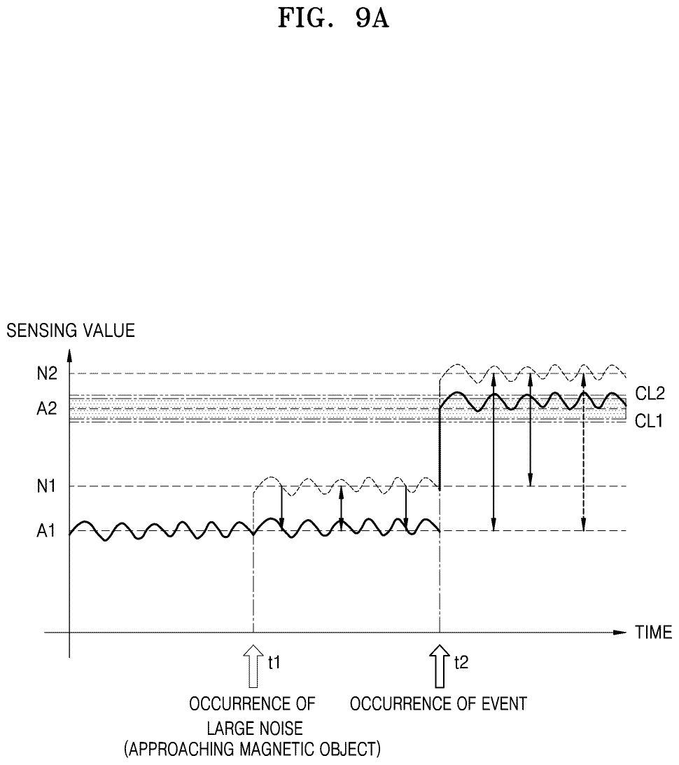

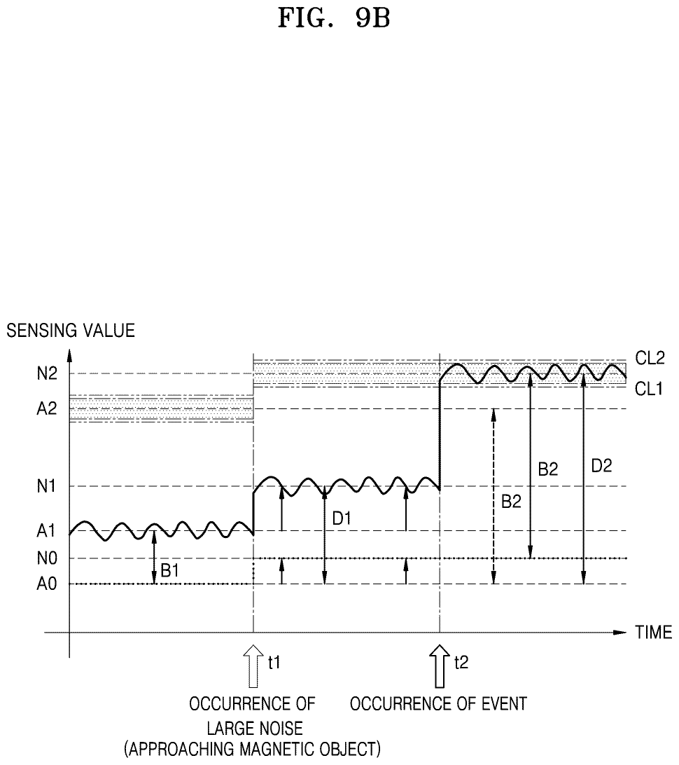

FIG. 9A is a view showing a result of calibrating a sensing value based on an initial value in the condition of FIG. 8A. FIG. 9B is a view showing a result of calibrating a reference value based on the sensing value in the condition of FIG. 8B.

Referring to FIGS. 9A and 9B, when the sensing value changes due to noise, the controller may calibrate the sensing value or the reference value. For example, the controller may calibrate the sensing value to be the same as a predetermined initial value. As another example, the controller may calibrate the reference value based on the sensing value, such that the reference value maintains a predetermined difference from the sensing value.

When the sensing value generated by the inductive sensor changes, and when the changing sensing value does not correspond to a certain range, the controller may calibrate the changing sensing value based on the initial value or may calibrate the reference value based on the changing sensing value. Here, “the condition in which the sensing value corresponds to a certain range” may denote a condition in which the sensing value changes because a certain event occurs.

What is important is that calibration is not to be performed when the sensing value changes due to the occurrence of a certain event. Thus, the controller may calibrate the sensing value or the reference value, when the controller determines, as a result of sensing, that a certain event has not occurred.

Here, for example, when the controller determines whether or not a certain event has occurred, based on the critical value, there may be a problem of determining that a certain event has occurred, although the corresponding event has not occurred, as described above.

This problem may be solved, when a user sets a critical range. By setting the critical range to be proximate to A2, which is the sensing value indicating that a certain event has occurred, the problem above may be solved as much as possible. For example, as illustrated, the range between CL1 and the CL2 may be set as the critical range.

Hereinafter, the case where the sensing value is calibrated to comply with the initial value in the natural state and the case where the reference value is calibrated according to the changing sensing value are sequentially described.

Referring to FIG. 9A, the controller may set the initial value as A1, which is the sensing value in a natural state with no noise. In this case, when large noise is generated and the sensing value changes from A1 to N1, the controller may determine, as a result of the sensing, that a certain event has not occurred, and may calibrate the sensing value from N1 to A1, which is the initial value.

When the calibration is not performed, because the sensing value may change from N1 to N2 when a certain event occurs, the controller may not determine that the corresponding event has occurred, as described with reference to FIG. 8A.

However, when the calibration is performed, because the sensing value may change from A1 to A2 when a certain event occurs, the controller may normally determine that the corresponding event has occurred, as described with reference to FIG. 7A.

Referring to FIG. 9B, the reference value is preset as A0. In this case, when large noise is generated and the sensing value changes from A1 to N1, the controller may determine, as a result of the sensing, that a certain event has not occurred, and may calibrate the reference value from A0 to N0. Here, to calibrate the reference value, A1 and N1 may be referred to.

As illustrated, the degree of change from A1 to N1 and the degree of change from A0 to N0 may be the same in terms of the change amount. However, an embodiment is not limited to what is illustrated. According to an algorithm for calibration, the degree of change of the sensing value may be the same as or different from the degree of change of the reference value, in terms of the change rate.

As the reference value is calibrated, CL1 and CL2, which are the upper limit value and the lower limit value of the critical range, and A2, which is the sensing value when a certain event occurs, may be calibrated. As a result of the calibration, the difference between the critical range and the reference value and the difference between the sensing value and the reference value may be the same as pre-noise generation.

When the calibration is not performed, the reference value is maintained as A0 while the sensing value is changing from N1 to N2 due to the occurrence of a certain event, and thus, as described with reference to FIG. 8B, the controller may not determine that the event has occurred.

However, when the calibration is performed, the reference value is calibrated as N0 while the sensing value is changing from N1 to N2 due to the occurrence of a certain event, and, as described above, the difference value between N0 and N2 is the same as B2, which is the difference value between A0 and A2, and thus, the controller may normally determine that the event has occurred, as described with reference to FIG. 7B.

Hereinafter, examples of calibrating the sensing value or the reference value according to a certain cycle are to be described. Here, the certain cycle may denote, for example, 1 hour, 20 minutes, 10 minutes, 5 minutes, 1 minute, 30 seconds, or 10 seconds, and a user may set a calibration cycle by taking into account improvement of the reliability with respect to the determination of the controller (e.g., the reliability is improved as the calibration cycle decreases) and power consumption of the inductive sensor and the controller (e.g., the power consumption is reduced as the calibration cycle increases).

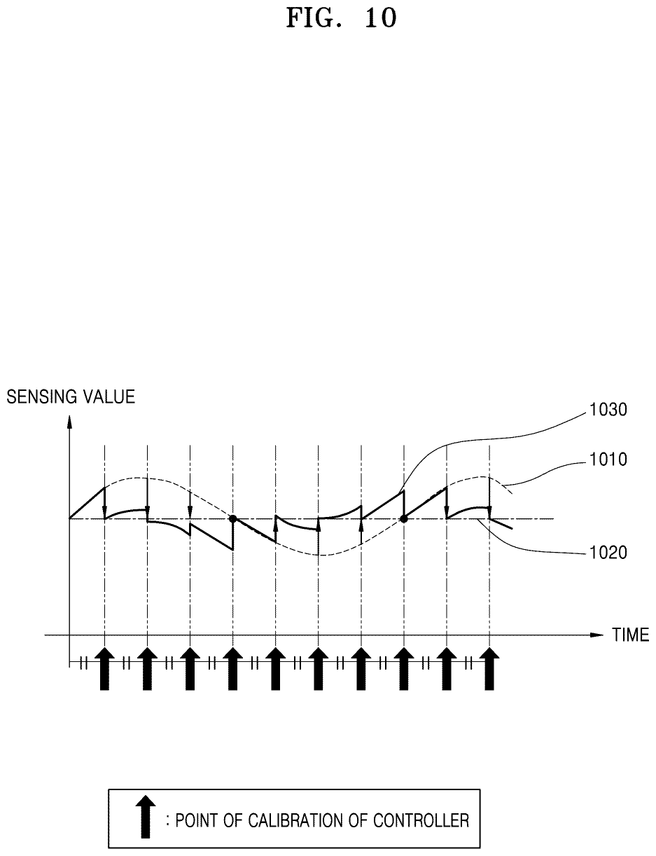

FIG. 10 is a view showing an example of calibrating a sensing value according to a certain cycle in a condition in which the sensing value cyclically changes.

Referring to FIG. 10, a graph with respect to a result of calibrating a cyclically changing sensing value according to a certain cycle is illustrated. The meaning of the axes of the graph may be the same as described above. The controller may calibrate the sensing value according to a certain cycle set by a user.

First, the condition in which the sensing value cyclically changes may be, for example, a condition in which a magnetic object repeatedly approaches and then draws away from an inductive sensor according to a certain cycle. In detail, when there are an aerosol generating device and a key including metal in a trouser pocket of a user, whenever the user walks, the trouser pocket may be shaken and the key may repeatedly approach and then draw away from the aerosol generating device.

In the illustrated graph, the waveform curve illustrated by dashed lines may denote an actual sensing value 1010 changing due to noise. The horizontal line illustrated as the one-point chain line may denote an initial value 1020, which is a sensing value in a natural state not affected by noise. The irregular solid line may denote a calibrated sensing value 1030. Here, one of ordinary skill in the art may easily understand that there are portions of the dashed lines covered by the solid line and not seen.

The controller may calibrate the actual sensing value 1010 according to a certain cycle. The controller may calibrate a reference value based on an initial value at a certain time point. Here, the initial value may have a certain value according to time. At a point of calibration, the controller may calibrate the actual sensing value 1010 as the initial value 1020. Thus, the calibrated sensing value 1030 may be the same as the initial value 1020 at every point of calibration.

During one cycle until a next point of calibration after the actual sensing value 1010 is calibrated as the initial value 1020, the calibrated sensing value 1030 may change according to the change of the actual sensing value 1010. That is, when the calibrated sensing value 1030 during the one cycle is shifted in parallel in a y axis direction, the calibrated sensing value 1030 may be the same as the actual sensing value 1010.

As the calibration cycle decreases, the calibrated sensing value 1030 may have a similar shape with the initial value 1020. As the calibrated sensing value 1030 is similar to the initial value 1020, the reliability of the controller with respect to the result of determining whether or not a certain event has occurred may be improved.

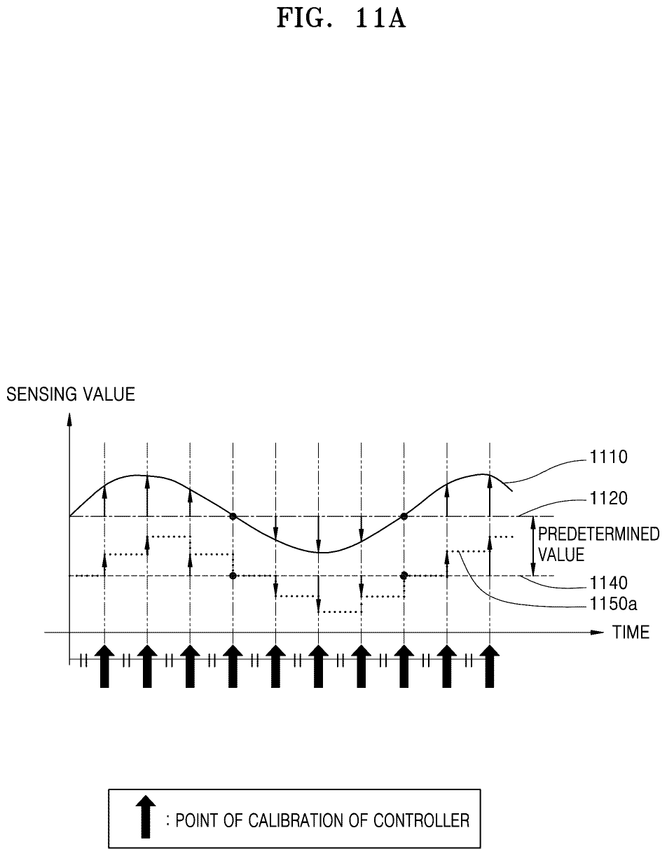

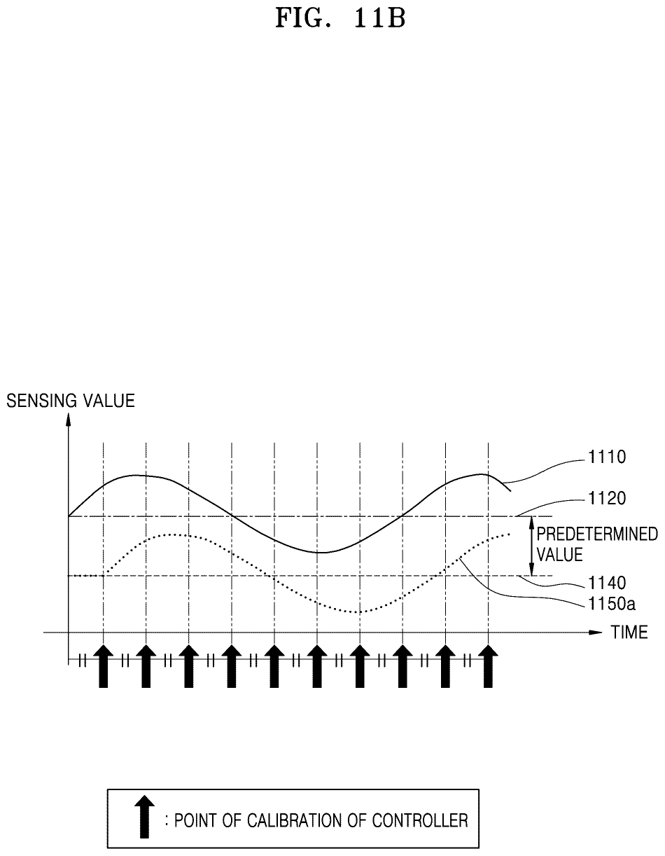

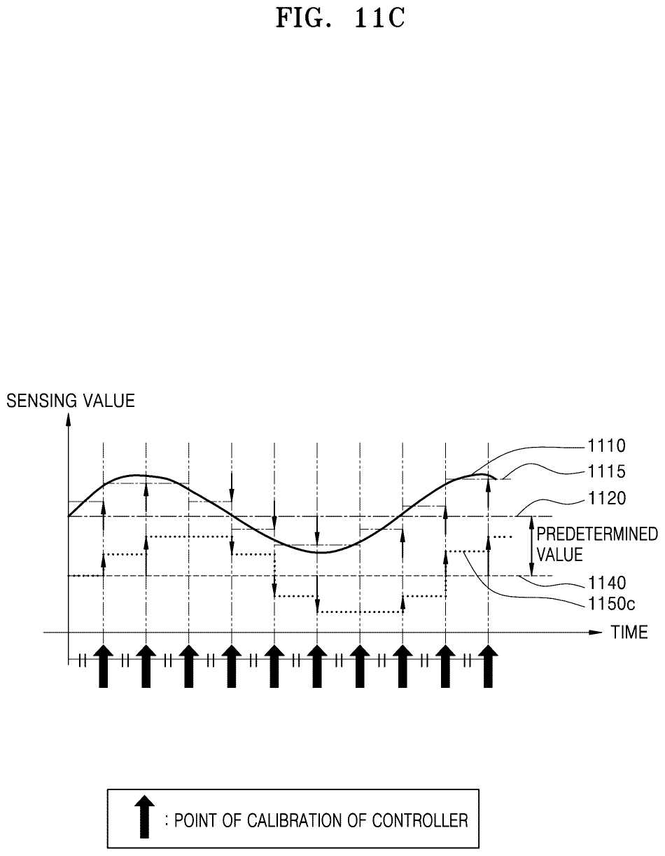

FIGS. 11A to 11C are each a view showing an example of calibrating a reference value according to a certain cycle in a condition in which a sensing value cyclically changes.

Referring to FIGS. 11A to 11C, a graph with respect to a result of calibrating, based on the sensing value cyclically changing, the reference value according to a cycle, is illustrated. The meaning of the axes of the graph may be the same as described above. The controller may calibrate the reference value according to a certain cycle set by a user.

Referring to FIG. 11A, the waveform curve illustrated by a solid line may denote an actual sensing value 1010 changing due to noise. The horizontal line illustrated as the one-point chain line may denote an initial value 1020, which is a sensing value in a natural state not affected by noise. The horizontal line illustrated by dashed lines may denote a pre-calibration reference value 1140. The stair-shaped thick dashed lines may denote a calibrated reference value 1150a. Here, the difference between the initial value 1120 and the pre-calibration reference value 1140 may have a predetermined value.

The controller may calibrate the pre-calibration reference value 1140 according to a certain cycle. The controller may calibrate the reference value based on the sensing value at a certain time point. In detail, the controller may calibrate the pre-calibration reference value 1140 by referring to the initial value 1120 and the actual sensing value 1110. At a point of calibration, the controller may derive the calibrated reference value 1150a by reflecting the difference between the initial value 1120 and the actual sensing value 1110 to the pre-calibration reference value 1140.

Thus, the difference between the initial value 1120 and the actual sensing value 1110 at the point of calibration may be the same as the difference between the pre-calibration reference value 1140 and the calibrated reference value 1150a. When the calibrated reference value 1150a is shifted in parallel in a y axis direction, the calibrated reference value 1150a may be the same as the actual sensing value 1110 at every point of calibration. During one cycle until a next point of calibration after the pre-calibration reference value 1140 is calibrated as the calibrated reference value 1150a, the calibrated reference value 1150a may maintain a certain value.

As the calibration cycle decreases, the calibrated reference value 1150a may have a similar shape with the changing actual sensing value 1110. As the shape of the calibrated reference value 1150a is similar to the shape of the actual sensing value 1110, the calibrated reference value 1150a may be similar to a result of simply shifting the actual sensing value 1110 in parallel in the y axis direction.

Ideally, the difference between the calibrated reference value 1150a and the actual sensing value 1110 may be the same at all time points. The corresponding difference may be the same as the predetermined “difference between the initial value 1120 and the pre-calibration reference value 1140.” That is, the change of the sensing value due to noise may be offset by the change of the reference value. As a result, the reliability of the controller with respect to a result of determining whether or not a certain event has occurred, may be improved.

Referring to FIG. 11B, the actual sensing value 1110, the initial value 1120, and the pre-calibration reference value 1140 may be the same as illustrated in FIG. 11A. However, the shape of a calibrated reference value 1150b is different from FIG. 11A. FIG. 11B illustrates the calibrated reference value 1150b that is calibrated to have the same shape as the actual sensing value 1110 after a first point of calibration.

The controller may calibrate the pre-calibration reference value 1140 according to a certain cycle. When a certain time point (e.g., a point of calibration) at which the reference value is calibrated is reached according to a certain cycle, the controller may calibrate the pre-calibration reference value 1140 by referring to the actual sensing value 1110. At the point of calibration, the controller may derive the calibrated reference value 1150b by reflecting the actual sensing value 1110 during a previous cycle to the pre-calibration reference value 1140. That is, the controller may calibrate the reference value to be in compliance with the change of the sensing value during the previous cycle based on a certain time point.

Thus, when the calibrated reference value 1150b is shifted in parallel in a +y direction and a −x direction, the calibrated reference value 1150b may be the same as the actual sensing value 1110. During one cycle until a next point of calibration after the pre-calibration reference value 1140 is calibrated as the calibrated reference value 1150b, the calibrated reference value 1150b may change according to the change of the actual sensing value 1110 of the previous cycle.

As the calibration cycle decreases, the disparity in an x axis direction between the calibrated reference value 1150b and the actual sensing value 1110 may decrease. As the disparity in the x axis direction decreases, the calibrated reference value 1150b may be similar to a result of simply shifting the actual sensing value 1110 in parallel in the y axis direction.

Ideally, the difference between the calibrated reference value 1150b and the actual sensing value 1110 may be the same at all time points. The corresponding difference may be the same as the predetermined “difference between the initial value 1120 and the pre-calibration reference value 1140.” That is, the change of the sensing value due to noise may be offset by the change of the reference value. As a result, the reliability of the controller with respect to a result of determining whether or not a certain event has occurred, may be improved.

Referring to FIG. 11C, the actual sensing value 1110, the initial value 1120, and the pre-calibration reference value 1140 may be the same as illustrated in FIG. 11A. However, the shape of a calibrated reference value 1150c is different from FIG. 11A. Also, an average value 1115 of the actual sensing value 1110 during one cycle is illustrated.

The controller may calibrate the pre-calibration reference value 1140 according to a certain cycle. The controller may calibrate the pre-calibration reference value 1140 with reference to the average value 1115 of the actual sensing value 1110 during one cycle. At a point of calibration, the controller may derive the calibrated reference value 1150c by reflecting the average value 1115 of a previous cycle to the pre-calibration reference value 1140.

Thus, the difference between the initial value 1120 and the average value 1115 of the previous cycle at the point of calibration may be the same as the difference between the pre-calibration reference value 1140 and the calibrated reference value 1150c. When the calibrated reference value 1150c is shifted in parallel in a +y direction and a −x direction, the calibrated reference value 1150c may be the same as the average value 1115 of the actual sensing value 1110. During one cycle until a next point of calibration after the pre-calibration reference value 1140 is calibrated as the calibrated reference value 1150c, the calibrated reference value 1150c may maintain a certain value.

As the calibration cycle decreases, the disparity in an x axis direction between the calibrated reference value 1150c and the average value 1115 may decrease, and the calibrated reference value 1150c may have a similar shape with the changing actual sensing value 1110. As the disparity in the x axis direction decreases and the shape of the calibrated reference value 1150c is similar to the shape of the actual sensing value 1110, the calibrated reference value 1150c may be similar to a result of simply shifting the actual sensing value 1110 in parallel in a y axis direction.

Ideally, the difference between the calibrated reference value 1150c and the actual sensing value 1110 may be the same at all time points. The corresponding difference may be the same as the predetermined “difference between the initial value 1120 and the pre-calibration reference value 1140. That is, the change of the sensing value due to noise may be offset by the change of the reference value. As a result, the reliability of the controller with respect to a result of determining whether or not a certain event has occurred may be improved.

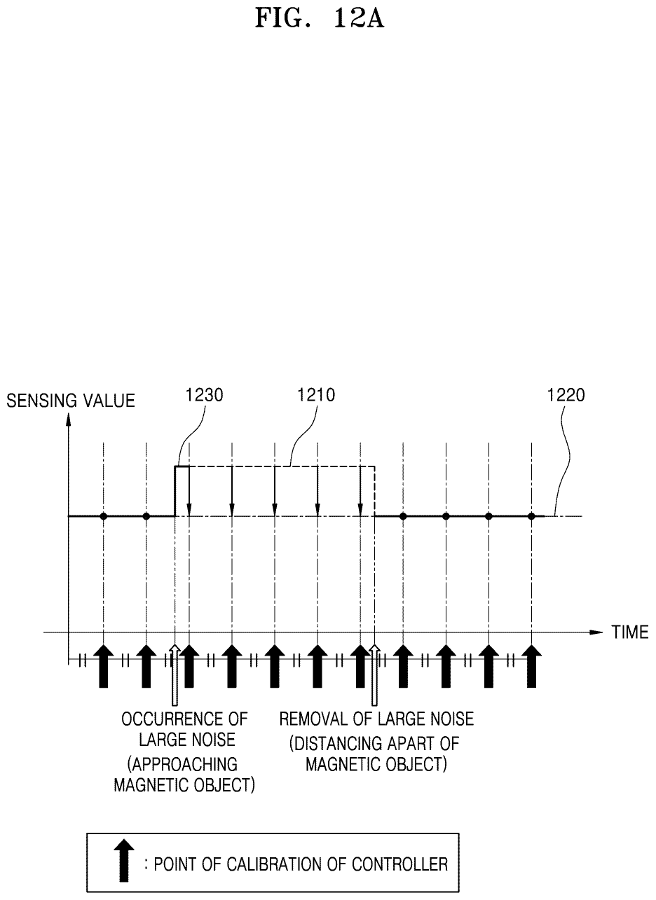

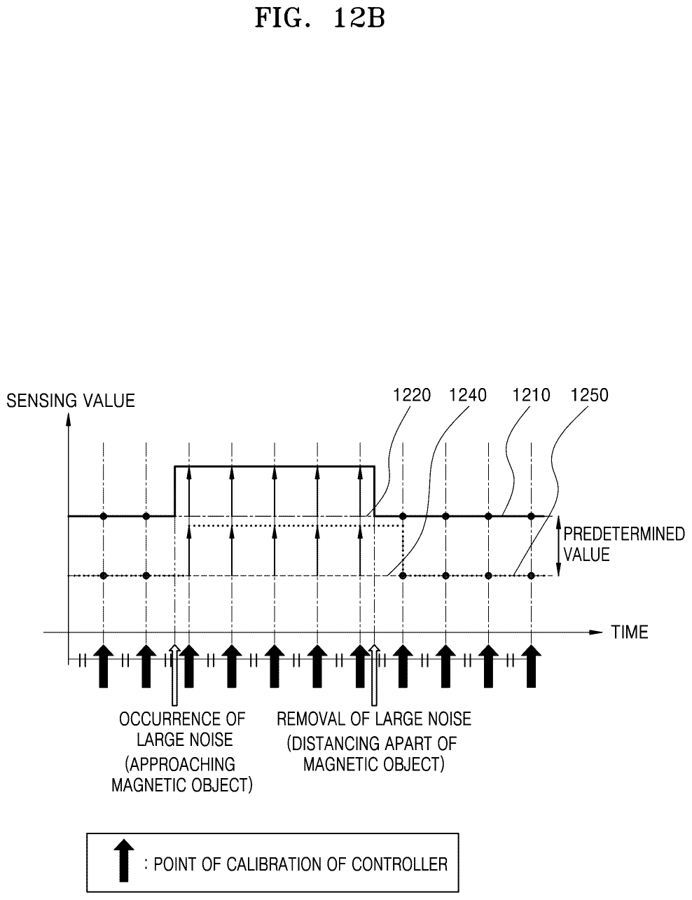

FIG. 12A is a view showing an example of calibrating a sensing value according to a certain cycle in a condition in which a magnetic object approaches and then draws away from an inductive sensor. FIG. 12B is a view showing an example of calibrating a reference value according to a certain cycle in a condition in which a magnetic object approaches and then draws away from an inductive sensor.

Referring to FIGS. 12A and 12B, a graph with respect to a result of calibrating the sensing value according to a certain cycle is illustrated, the sensing value increasing and decreasing according to a movement of the magnetic object. The meaning of the axes of the graph may be the same as described above.

First, the condition in which the sensing value increases and then decreases may be, for example, a condition in which the magnetic object approaches and then draws away from the inductive sensor. In this case, the inclination of the graph may be determined according to a moving speed of the magnetic object. Here, a condition is assumed, in which the magnetic object instantly approaches the inductive sensor and maintains a distance thereto, and then, instantly draws away from the inductive sensor.

Referring to FIG. 12A, the line illustrated by dashed lines may denote an actual sensing value 1210 changing due to noise. The horizontal line illustrated by the one point chain line may denote an initial value 1220, which is a sensing value in a natural state not affected by noise. The solid line may denote a calibrated sensing value 1230. Here, one of ordinary skill in the art may easily understand that there are portions of the dashed lines covered by the solid line and not seen.

As described with reference to FIG. 10, the controller may calibrate the actual sensing value 1210 as the initial value 1220 according to a certain cycle. The calibrated sensing value 1230 may be the same as the initial value 1220 at every point of calibration. Also, during one cycle until a next point of calibration, the calibrated sensing value 1230 may change according to the change of the actual sensing value 1210. In this condition, except for one term of increase/decrease, there is no change of the actual sensing value 1210, and thus, at most of the time, the calibrated sensing value 1230 may be the same as the initial value 1220.

As the calibration cycle decreases, a time gap between a rising time point and a falling time point of the calibration sensing value 1230 may decrease. As the time gap decreases, the calibrated sensing value 1230 may maintain the state of the initial value 1220, except for one term of impulse in the calibrated sensing value 1230, and thus, the reliability of the controller with respect to a result of determining whether or not a certain event has occurred may be improved.

Referring to FIG. 12B, the line illustrated by a solid line may denote the actual sensing value 1210 changing due to noise. The horizontal line illustrated by the one point chain line may denote the initial value 1220, which is a sensing value in a natural state not affected by noise. The horizontal line illustrated by dashed lines may denote a pre-calibration reference value 1240. The thick dashed lines may denote a calibrated reference value 1250.

As described with reference to FIG. 11A, the controller may calibrate the pre-calibration reference value 1240 according to a certain cycle. The controller may calibrate the pre-calibration reference value 1240 by referring to the initial value 1220 and the actual sensing value 1210. At a point of calibration, the controller may derive the calibrated reference value 1250 by reflecting the difference between the initial value 1220 and the actual sensing value 1210 to the pre-calibration reference value 1240.

Thus, the difference between the initial value 1220 and the actual sensing value 1210 at the point of calibration may be the same as the difference between the pre-calibration reference value 1240 and the calibrated reference value 1250. When the calibrated reference value 1250 is shifted in parallel in a y axis direction, the calibrated reference value 1250 may be the same as the actual sensing value 1210 at all points of calibration. During one cycle until a next point of calibration after the pre-calibration reference value 1240 is calibrated as the calibrated reference value 1250, the calibrated reference value 1250 may maintain a certain value.

As the calibration cycle decreases, the calibrated reference value 1250 may have a similar shape with the changing actual sensing value 1210. In particular, as a point at which the actual sensing value 1210 changes is near to the next point of calibration, the shape of the calibrated reference value 1250 may be similar to the shape of the actual sensing value 1210. Thus, the calibrated reference value 1250 may be similar to a result of simply shifting the actual sensing value 1210 in parallel in the y axis direction.

Ideally, the difference between the calibrated reference value 1250 and the actual sensing value 1210 may be the same at all time points. The corresponding difference may be the same as the predetermined “difference between the initial value 1220 and the pre-calibration reference value 1240.” That is, the change of the sensing value due to noise may be offset by the change of the reference value. As a result, the reliability of the controller with respect to determining whether or not a certain event has occurred may be improved.

Hereinafter, examples of calibrating the sensing value or the reference value after a user starts smoking are to be described.

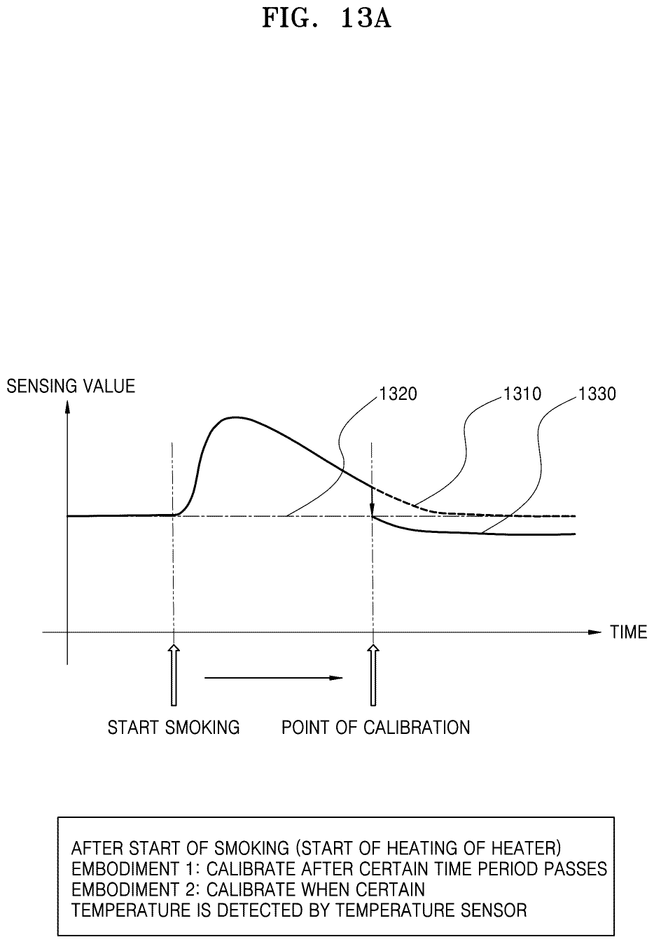

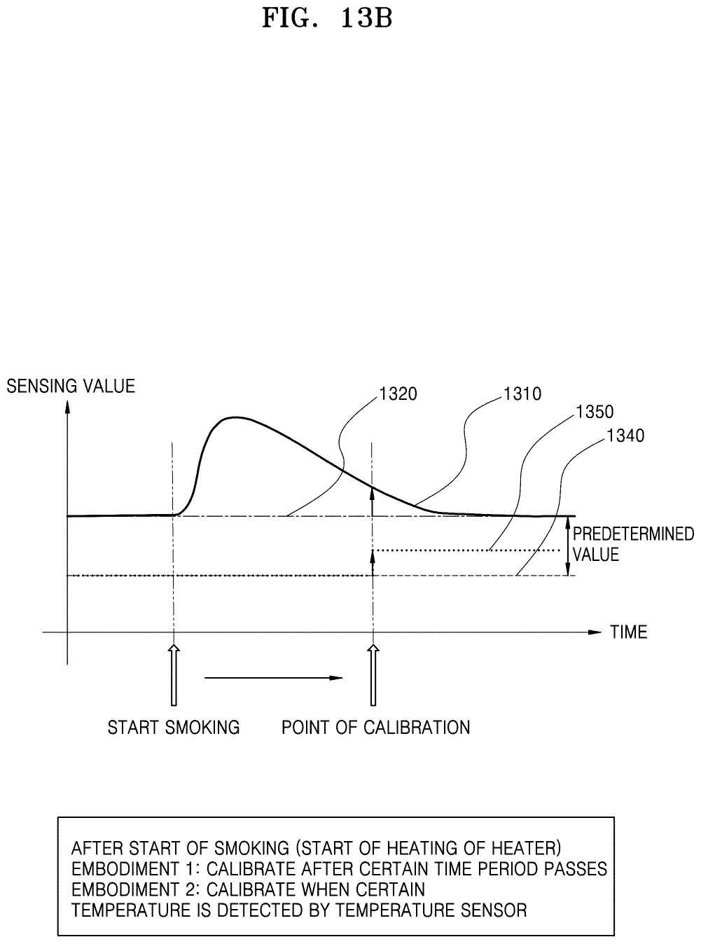

FIG. 13A is a view showing an example of calibrating a sensing value after a certain time period passes after a heater starts heating. FIG. 13B is a view showing an example of calibrating a reference value after a certain time period passes after the heater starts heating.

Referring to FIGS. 13A and 13B, a graph with respect to a result of calibrating the sensing value changing due to an effect of heating of a heater, is illustrated. Here, the calibration may be performed after a certain time period passes after the heater starts heating. The meaning of the axes of the graph may be the same as described above.

That a user starts smoking may denote that the heater starts heating. The sensing value of an inductive sensor may change according to the effect of heat generated by the heater. Here, it is not that the sensing value changes due to the occurrence of a certain event. Rather, the sensing value may change due to a surrounding environmental factor, and thus, it may be regarded that the sensing value may change due to noise. Also, the change of the sensing value is not limited to the illustrated change.

The sensing value of the inductive sensor may sensitively react with the heat of the heater. That is, as the temperature of the heater continually changes during smoking, the sensing value of the inductive sensor may continually change. Thus, to calibrate the sensing value or a reference value while the sensing value is sophisticatedly and rapidly changing due to the effect of the heat of the heater may be relatively more difficult than the calibration at other times and may increase power consumption.

Also, it is less probable that a certain event occurs while the user is smoking. For example, when the user is smoking, an aerosol generating article is already inserted into an insertion space, and thus, there is no need to determine whether or not the aerosol generating article is inserted into the insertion space, and in this state, there is also no need to separate or mount a cap, and thus, there is no need to determine whether or not the cap is mounted/separated. Thus, from the point at which the heating of the heater is started, the need to calibrate the sensing value or the reference value decreases.

For this reason, a controller of an aerosol generating device according to an embodiment may calibrate the sensing value or the reference value after a certain time period passes after the heating of the heater is started. Here, the certain time period may vary according to setting of a user. For example, the certain time period may denote about 10 minutes which is a time period sufficient for the user to finish smoking. However, an embodiment is not limited to 10 minutes.

According to another embodiment, when the aerosol generating device includes a temperature sensor to sense the temperature of the heater, the controller may calibrate the sensing value or the reference value when the room temperature (e.g., 20° C. to 30° C.) is detected by the temperature sensor. In detail, the controller may determine the temperature of the heater according to a signal generated by the temperature sensor, and when the temperature of the heater reaches a certain temperature, the controller may calibrate the sensing value or the reference value.

Although not shown, the controller may set the sensing value when the temperature of the heater reaches a certain temperature, as an initial value. For example, when the room temperature (e.g., 20° C. to 30° C.) is detected by the temperature sensor, the controller may deem this condition as a natural state without any noise and may set the sensing value in this condition as the initial value. The controller may store, in a memory, the sensing value as the initial value. Accordingly, the controller may reset the initial value.

Referring to FIG. 13A, the curved line illustrated by dashed lines may denote an actual sensing value 1310 changing due to noise. The horizontal line illustrated by the one point chain line may denote an initial value 1320, which is a sensing value in a natural state not affected by noise. The irregular solid line may denote a calibrated sensing value 1330. Here, one of ordinary skill in the art may easily understand that there are portions of the dashed lines covered by the solid line and not seen.

After smoking is started (e.g., after heating of the heater is started), the controller may calibrate the sensing value 1310 after a certain time period passes or when the temperature sensor detects a certain temperature. At the point of calibration, the controller may calibrate the actual sensing value 1310 as the initial value 1320. The calibrated sensing value 1330 may change according to a change of the actual sensing value 1310.

Referring to FIG. 13B, the curved line illustrated by a solid line may denote the actual sensing value 1310 changing due to noise. The horizontal line illustrated by the one point chain line may denote the initial value 1320, which is the sensing value in the natural state not affected by noise. The horizontal line illustrated by dashed lines may denote a pre-calibration reference value 1340. The stair-shaped thick dashed lines may denote a calibrated reference value 1350. Here, the difference between the initial value 1320 and the pre-calibration reference value 1340 may have a predetermined value.

After the smoking is started (e.g., after the heating of the heater is started), the controller may calibrate the pre-calibration reference value 1340 after a certain time period passes or when the temperature sensor detects a certain temperature. The controller may calibrate the pre-calibration reference value 1340 by referring to the initial value 1320 and the actual sensing value 1310. At the point of calibration, the controller may derive the calibrated reference value 1350 by reflecting the difference between the initial value 1320 and the actual sensing value 1310 to the pre-calibration reference value 1340. The difference between the initial value 1320 and the actual sensing value 1310 at the point of calibration may be the same as the difference between the pre-calibration reference value 1340 and the calibrated reference value 1350. Thereafter, the calibrated reference value 1350 may maintain a certain value.

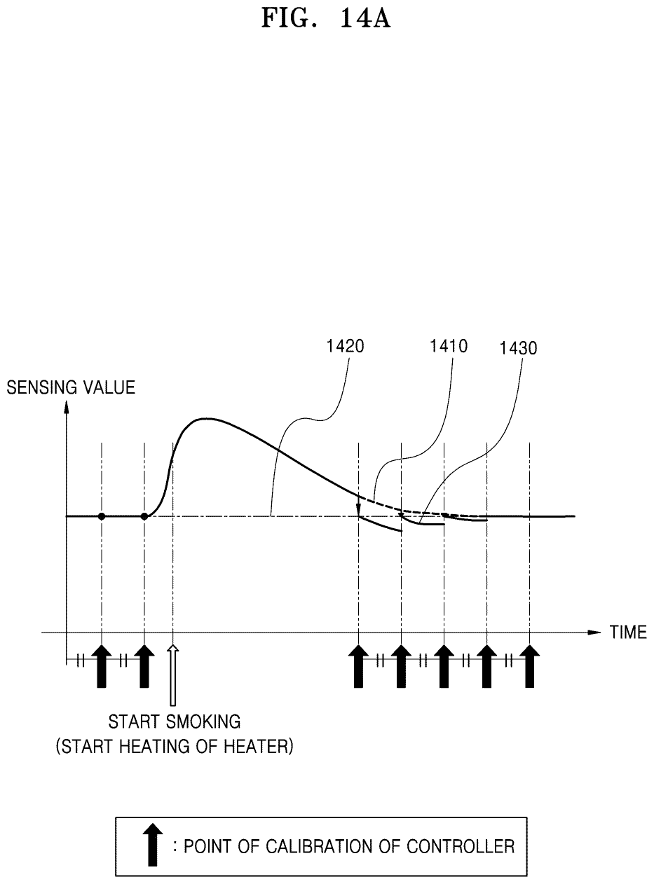

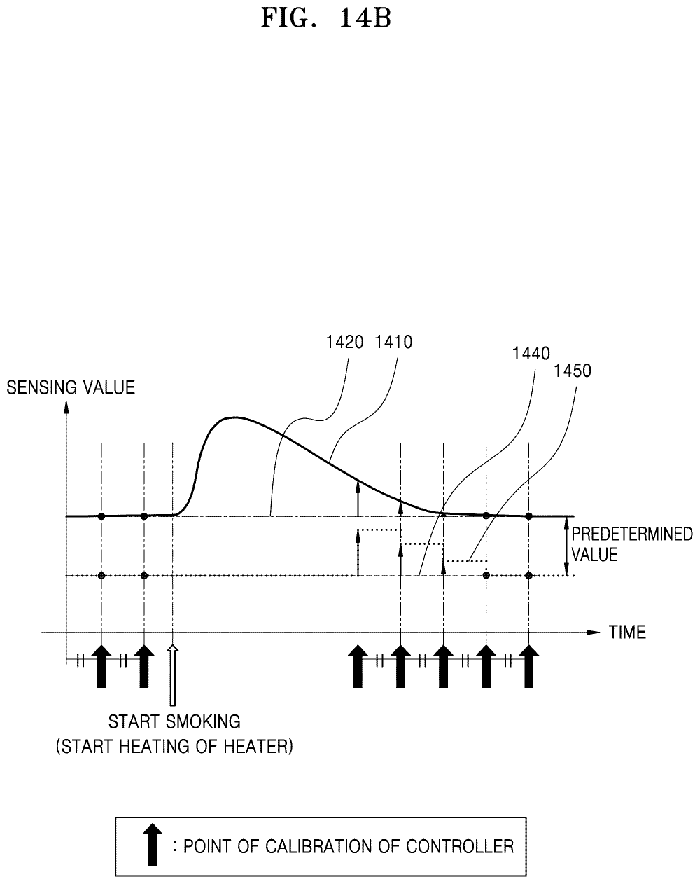

FIG. 14A is a view showing an example of calibrating a sensing value according to a certain cycle, whereby, after a heater starts heating, the sensing value is calibrated according to the certain cycle again after a certain time period passes. FIG. 14B is a view showing an example of calibrating a reference value according to a certain cycle, whereby, after the heater starts heating, the reference value is calibrated according to the certain cycle again after a certain time period passes.

Referring to FIGS. 14A and 14B, a graph is illustrated to show a condition in which the sensing value or the reference value is additionally calibrated according to a certain cycle in the condition of FIG. 13A or 13B. The meaning of the axes of the graph may be the same as described above.

The controller may calibrate the sensing value or the reference value according to a certain cycle. However, after smoking is started (e.g., heating of the heater is started), the controller may not perform calibration until a certain time period passes therefrom or a certain temperature is detected by the temperature sensor. After a certain time period passes or when a certain temperature is detected, the controller may, from that point on, calibrate the sensing value or the reference value again. Beginning at that point, calibration may be performed according to a certain cycle again.

Referring to FIG. 14A, the line illustrated by dashed lines may denote an actual sensing value 1410 changing due to noise. The horizontal line illustrated as the one-point chain line may denote an initial value 1420, which is a sensing value in a natural state not affected by noise. The irregular solid line may denote a calibrated sensing value 1430. Here, one of ordinary skill in the art may easily understand that there are portions of the dashed lines covered by the solid line and not seen.

The controller may calibrate the actual sensing value 1410 according to a certain cycle. However, as described above, when smoking (e.g., the heating of the heater) is started, the controller may not perform calibration even when the certain cycle is reached. That is, the controller may calibrate the sensing cycle according to a certain cycle, but after the heater starts heating, the controller may maintain the sensing value even when a certain time point for calibrating the sensing value according to the certain cycle is reached. Thereafter, after a certain time period passes or when a certain temperature is detected by the temperature sensor, the calibration may be resumed.

At the point of calibration, the controller may calibrate the actual sensing value 1410 as the initial value 1420. Thus, the calibrated sensing value 1430 may be the same as the initial value 1420 at every point of calibration.

During one cycle until a next point of calibration after the actual sensing value 1410 is calibrated as the initial value 1420, the calibrated sensing value 1430 may change according to the change of the actual sensing value 1410. That is, when the calibrated sensing value 1430 during the one cycle is shifted in parallel in a y axis direction, the calibrated sensing value 1430 may be the same as the actual sensing value 1410.

Except for values before the resumption of the calibration after the start of the smoking, the calibrated sensing value 1430 may have a similar shape with the initial value 1420 as the calibration cycle decreases. As the calibrated sensing value 1430 is similar to the initial value 1420, the reliability of the controller with respect to the result of determining whether or not a certain event has occurred may be improved.

Referring to FIG. 14B, the line illustrated by a solid line may denote the actual sensing value 1410 changing due to noise. The horizontal line illustrated as the one-point chain line may denote the initial value 1420, which is the sensing value in the natural state not affected by noise. The horizontal line illustrated by dashed lines may denote a pre-calibration reference value 1440. The thick dashed lines may denote a calibrated reference value 1450.

The controller may calibrate the pre-calibration reference value 1440 according to a certain cycle. However, as described above, when the smoking (e.g., the heating of the heater) is started, the controller may not perform the calibration even when the certain cycle is reached. That is, before a certain time period passes after the heater starts heating, the controller may maintain the reference value even when a certain time point for calibrating the reference value according to the certain cycle is reached. Thereafter, after a certain time period passes or when a certain temperature is detected by the temperature sensor, the calibration may be resumed.

The controller may calibrate the pre-calibration reference value 1440 by referring to the initial value 1420 and the actual sensing value 1410. At a point of calibration, the controller may derive the calibrated reference value 1450 by reflecting the difference between the initial value 1420 and the actual sensing value 1410 to the pre-calibration reference value 1440.

Thus, the difference between the initial value 1420 and the actual sensing value 1410 at the point of calibration may be the same as the difference between the pre-calibration reference value 1440 and the calibrated reference value 1450. When the calibrated reference value 1450 is shifted in parallel in a y axis direction, the calibrated reference value 1450 may be the same as the actual sensing value 1410 at all points of calibration. During one cycle until a next point of calibration after the pre-calibration reference value 1440 is calibrated as the calibrated reference value 1450, the calibrated reference value 1450 may maintain a certain value.

Except for values before the resumption of the calibration after the start of the smoking, the calibrated reference value 1450 may have a similar shape with the changing actual sensing value 1410 as the calibration cycle decreases. In particular, as a point at which the actual sensing value 1410 changes is near to the next point of calibration, the shape of the calibrated reference value 1450 may be similar to the shape of the actual sensing value 1410. Thus, the calibrated reference value 1450 may be similar to a result of simply shifting the actual sensing value 1410 in parallel in the y axis direction.

Ideally, the difference between the calibrated reference value 1450 and the actual sensing value 1410 may be the same at all time points. The corresponding difference may be the same as the predetermined “difference between the initial value 1420 and the pre-calibration reference value 1440.” That is, the change of the sensing value due to noise may be offset by the change of the reference value. As a result, the reliability of the controller with respect to determining whether or not a certain event has occurred may be improved.

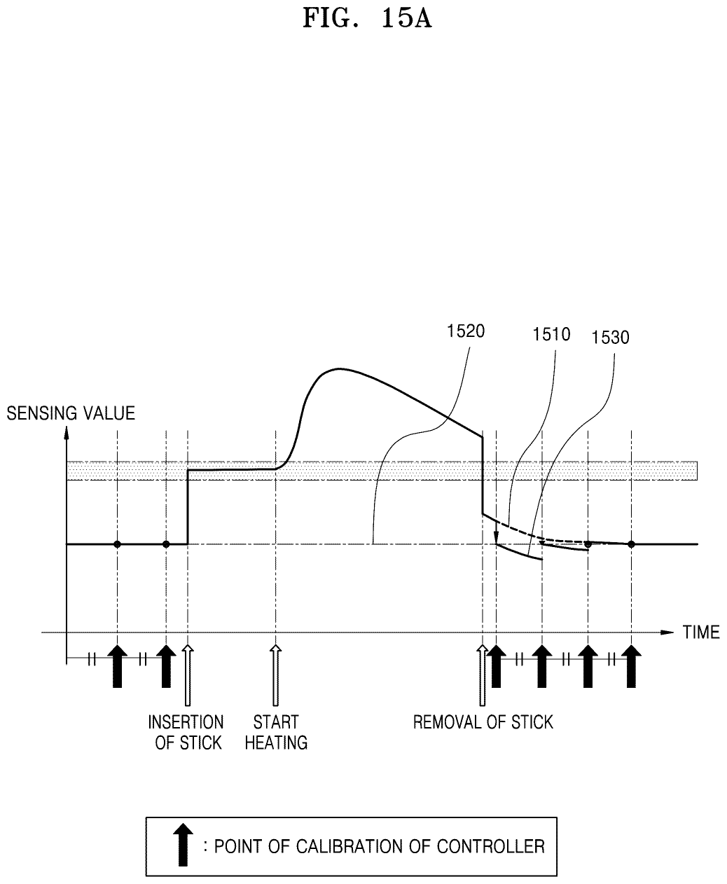

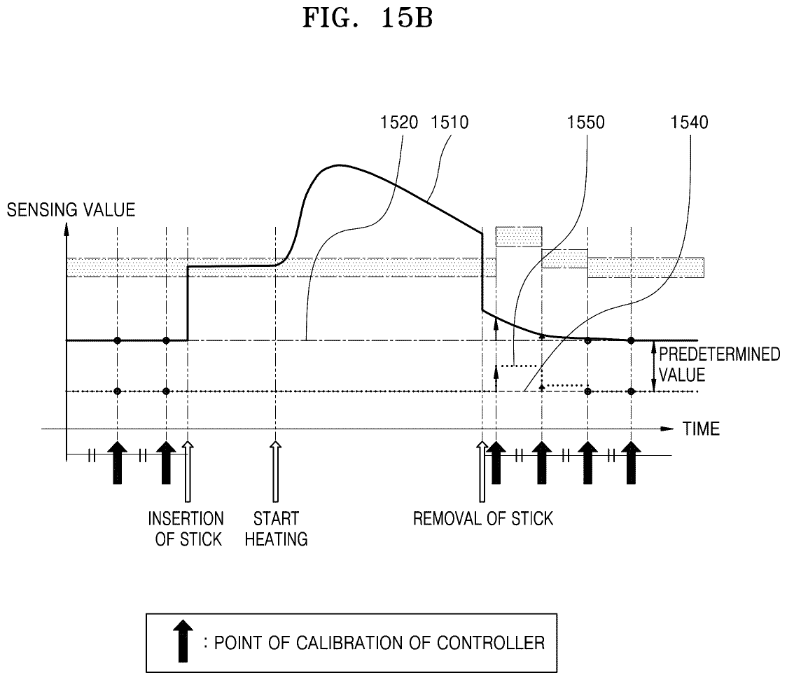

FIG. 15A is a view showing an example of calibrating a sensing value according to a certain cycle, whereby, after an aerosol generating article is inserted, the sensing value is calibrated according to the certain cycle again after the aerosol generating article is removed. FIG. 15B is a view showing an example of calibrating a reference value according to a certain cycle, whereby, after the aerosol generating article is inserted, the reference value is calibrated according to the certain cycle again after the aerosol generating article is removed.

Referring to FIGS. 15A and 15B, a graph is illustrated to show a condition in which a stick, which is the aerosol generating article, is additionally inserted and removed in the condition of FIG. 14A or 14B. The meaning of the axes of the graph may be the same as described above.

The controller may calibrate the sensing value or the reference value according to a certain cycle. When the stick is inserted into an insertion space after a certain time period passes, the controller may determine, based on a result of sensing by the inductive sensor, that a certain event corresponding to insertion of the stick has occurred. After the stick is inserted into the insertion space, the controller may not perform calibration until a certain time period has passed after the insertion of the stick, or may not perform calibration before a certain temperature is detected by the temperature sensor. After a certain time period passes or when a certain temperature is detected, the controller may, from that point on, calibrate the sensing value or the reference value again. Beginning at that point, calibration may be performed according to the certain cycle again.

As illustrated, an event corresponding to removal of the stick from the insertion space may occur before a certain time period has passed after the insertion of the stick or may occur before a certain temperature is detected by the temperature sensor. Here, although not shown, if the event corresponding to the removal of the stick occurs after the certain time period passes or the certain temperature is detected by the temperature sensor, the controller may not perform the calibration until the stick is removed.

Referring to FIG. 15A, the line illustrated by dashed lines may denote an actual sensing value 1510 changing due to noise. The horizontal line illustrated as the one-point chain line may denote an initial value 1520, which is a sensing value in a natural state not affected by noise. The irregular solid line may denote a calibrated sensing value 1530. Here, one of ordinary skill in the art may easily understand that there are portions of the dashed lines covered by the solid line and not seen.

The controller may calibrate the actual sensing value 1510 according to a certain cycle. However, as described above, when the stick is inserted into the insertion space, the controller may not perform the calibration even when the certain cycle is reached. Thereafter, after a certain time period passes or when a certain temperature is detected by the temperature sensor, the calibration may be resumed.

The calibration method performed by the controller or its characteristic illustrated in FIG. 15A may be the same as described above with reference to FIG. 14A, and thus, its description is omitted here.

Referring to FIG. 15B, the line illustrated by a solid line may denote the actual sensing value 1510 changing due to noise. The horizontal line illustrated as the one-point chain line may denote the initial value 1520, which is the sensing value in the natural state not affected by noise. The horizontal line illustrated by dashed lines may denote a pre-calibration reference value 1540. The thick dashed lines may denote a calibrated reference value 1550.

The controller may calibrate the pre-calibration reference value 1540 according to a certain cycle. However, as described above, when the stick is inserted into the insertion space, the controller may not perform the calibration even when the certain cycle is reached. Thereafter, after a certain time period passes or when a certain temperature is detected by the temperature sensor, the calibration may be resumed.

The calibration method performed by the controller or its characteristic illustrated in FIG. 15B may be the same as described above with reference to FIG. 14B, and thus, its description is omitted here.

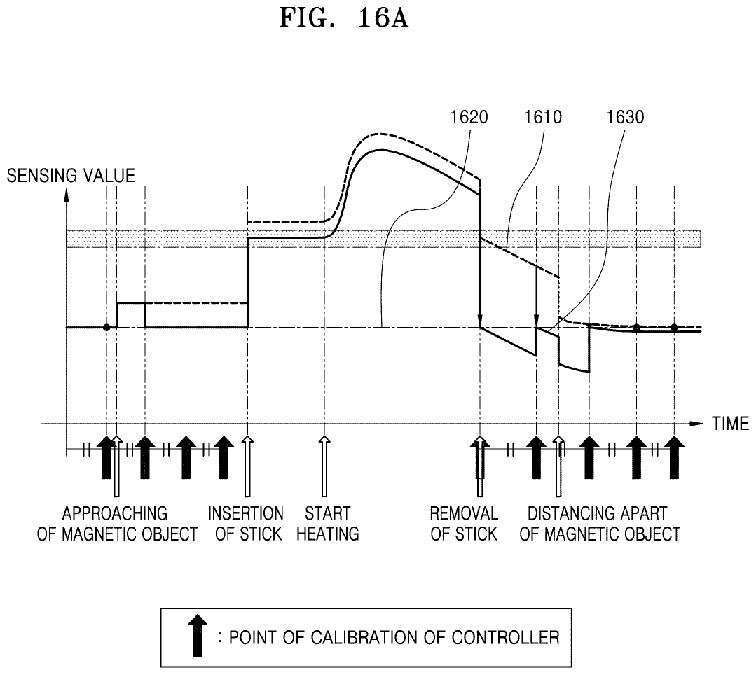

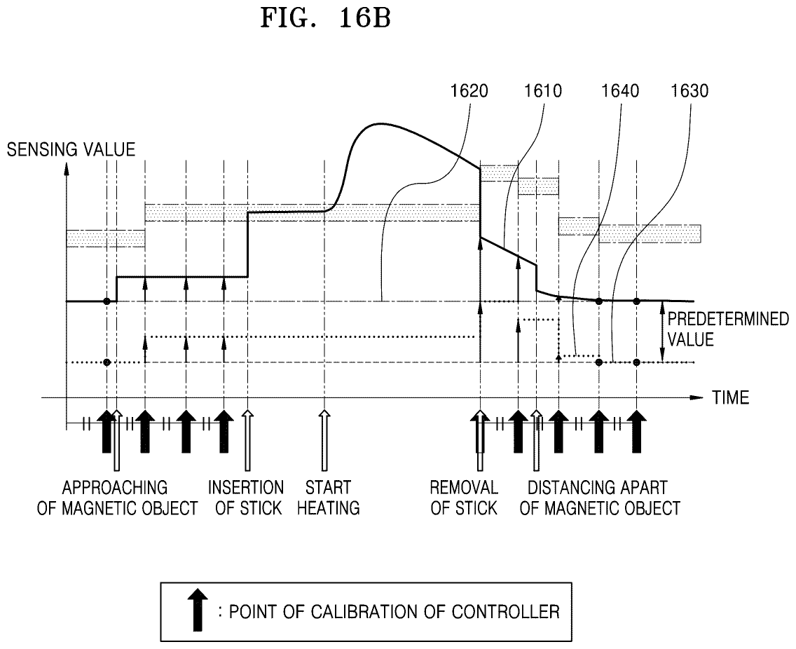

FIG. 16A is a view showing an example of calibrating a sensing value when a magnetic object is approached and then is distanced apart in the condition of FIG. 15A. FIG. 16B is a view showing an example of calibrating a reference value when the magnetic object is approached and then is distanced apart in the condition of FIG. 15B.

Referring to FIGS. 16A and 16B, a graph is illustrated to show a condition in which noise, for example, approaching of a magnetic object, occurs additionally in the condition of FIG. 15A or 15B, and then, the noise is removed as the magnetic object is distanced apart again. The meaning of the axes of the graph may be the same as described above.

The controller may calibrate the sensing value or the reference value according to a certain cycle. The controller may also calibrate the sensing value or the reference value before the noise (e.g., the approaching of the magnetic object) occurs. When the stick is inserted into the insertion space after a certain time period passes after the occurrence of the noise, the sensing value or the reference value may be calibrated. Thus, even though the noise has occurred previously, the controller may correctly determine that the event corresponding to insertion of the stick has occurred.

After the stick is inserted into the insertion space, the controller may not perform calibration until a specific event corresponding to removal of the stick occurs. When the stick is removed from the insertion space, the controller may determine, based on a result of sensing by the inductive sensor, that the specific event corresponding to the removal of the stick has occurred, and from that point on, may calibrate the sensing value or the reference value again. Beginning at that point, the calibration may be performed according to the certain cycle again.

However, an embodiment is not necessarily limited to the case where the calibration is resumed when the stick is removed. For example, calibration may not be performed until a certain time period has passed after the stick is inserted or until a certain temperature is detected by the temperature sensor. After the certain time period has passed or when the certain temperature is detected, the controller may, from that point on, calibrate the sensing value or the reference value again.

After the controller resumes the calibration, the controller may calibrate the sensing value or the reference value according to a certain cycle, even when the noise is removed as the magnetic object is drawn away from the inductive sensor.

Referring to FIG. 16A, the line illustrated by dashed lines may denote an actual sensing value 1610 changing due to noise. The horizontal line illustrated as the one-point chain line may denote an initial value 1620, which is a sensing value in a natural state not affected by noise. The irregular solid line may denote a calibrated sensing value 1630. Here, one of ordinary skill in the art may easily understand that there are portions of the dashed lines covered by the solid line and not seen.

The controller may calibrate the actual sensing value 1610 according to a certain cycle. However, as described above, when the stick is inserted into the insertion space, the controller may not perform the calibration even when the certain cycle is reached. Thereafter, the calibration may be resumed when the stick is removed from the insertion space.

The calibration method performed by the controller and its characteristic illustrated in FIG. 16A may be the same as described above with reference to FIG. 15A, and thus, its description is omitted here.

Referring to FIG. 16B, the line illustrated by a solid line may denote the actual sensing value 1610 changing due to noise. The horizontal line illustrated as the one-point chain line may denote the initial value 1620, which is the sensing value in the natural state not affected by noise. The horizontal line illustrated by dashed lines may denote a pre-calibration reference value 1640. The thick dashed lines may denote a calibrated reference value 1650.

The controller may calibrate the pre-calibration reference value 1640 according to a certain cycle. However, as described above, when the stick is inserted into the insertion space, the controller may not perform the calibration even when the certain cycle is reached. Thereafter, the calibration may be resumed when the stick is removed from the insertion space.

The calibration method performed by the controller and its characteristic illustrated in FIG. 16B may be the same as described above with reference to FIG. 15B, and thus, its description is omitted here.

According to an aerosol generating device according to embodiments, by calibrating a sensing value of an inductive sensor or a reference value, which is a reference for determination, precise sensing may be possible without malfunction of the inductive sensor or a controller, and the reliability of the controller with respect to a result of determination may be improved.

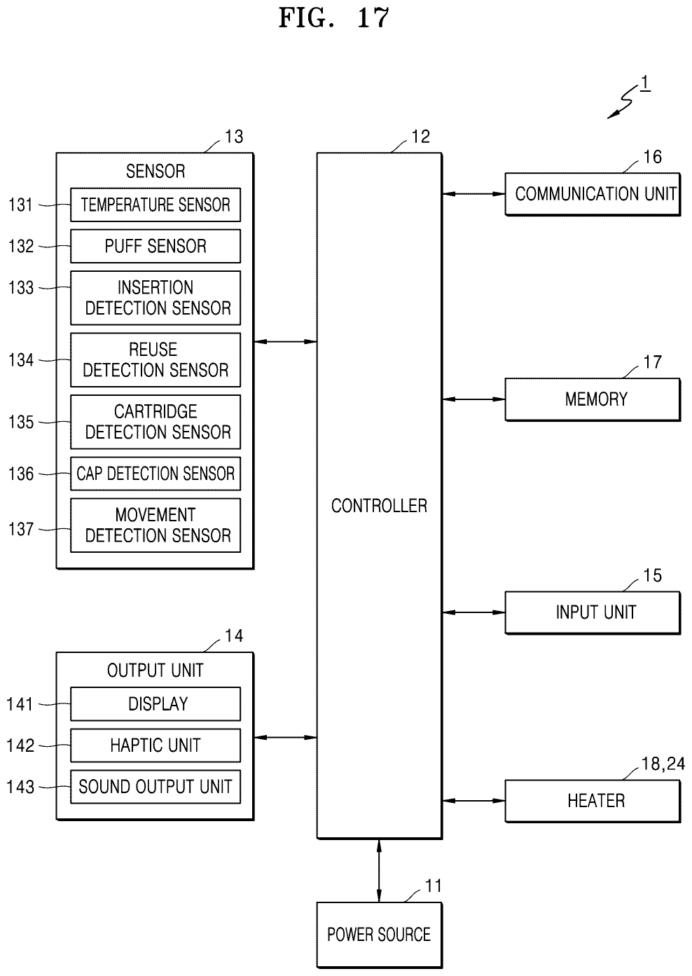

FIG. 17 is a block diagram of an aerosol generating device according to other embodiment of the present disclosure.

An aerosol generating device 1 may include a power source 11, a controller 12, a sensor 13, an output unit 14, an input unit 15, a communication unit 16, a memory 17, and one or more heaters 18 or 24. However, an internal structure of the aerosol generating device 1 is not limited to the illustration of FIG. 17. That is, it may be understood by those skilled in the art that some of the components shown in FIG. 17 may be omitted or new components may be added, according to the design of the aerosol generating device 1.

The sensor 13 may sense a state of the aerosol generating device 1 or a state of the surroundings of the aerosol generating device 1 and may transmit information corresponding to the sensed state to the controller 12. The controller 12 may control the aerosol generating device 1 so that various functions, such as operation control of the cartridge heater 24 and/or the heater 18, smoking restrictions, determination as to whether the stick S and/or the cartridge 19 is inserted, and an alarm display, may be performed, based on the information corresponding to the sensed state.

The sensor 13 may include at least one of a temperature sensor 131, a puff sensor 132, an insertion detection sensor 133, a reuse detection sensor 134, a cartridge detection sensor 135, a cap detection sensor 136, and a movement detection sensor 137.

The temperature sensor 131 may detect a temperature at which the cartridge heater 24 and/or the heater 18 is heated. The aerosol generating device 1 may include a separate temperature sensor for detecting the temperature of the cartridge heater 24 and/or the heater 18, or the cartridge heater 24 and/or the heater 18 may serve as a temperature sensor.

The temperature sensor 131 may output a signal corresponding to the cartridge heater 24 and/or the heater 18. For example, the temperature sensor 131 may include a resistor element of which resistance value changes according to a change in the temperature of the cartridge heater 24 and/or the heater 18. The temperature sensor 131 may be implemented by a thermistor, etc. which is an element using a property in which resistance changes according to a temperature. In this case, the temperature sensor 131 may output a signal corresponding to the resistance value of the resistor element as a signal corresponding to the temperature of the cartridge heater 24 and/or the heater 18. For example, the temperature sensor 131 may include a sensor for detecting the resistance value of the cartridge heater 24 and/or the heater 18. In this case, the temperature sensor 131 may output the signal corresponding to the resistance value of the cartridge heater 24 and/or the heater 18 as a signal corresponding to the temperature of the cartridge heater 24 and/or the heater 18.

The temperature sensor 131 may be disposed around the power source 11 to monitor a temperature of the power source 11. The temperature sensor 131 may be disposed adjacent to the power source 11. For example, the temperature sensor 131 may be attached to one surface of a battery, which is the power source 11. For example, the temperature sensor 131 may be mounted on one surface of a printed circuit board.

The temperature sensor 131 may be disposed inside the body 10 to detect an internal temperature of the body 10.

The puff sensor 132 may detect the user's puff, based on various physical changes in an airflow path. The puff sensor 132 may output a signal corresponding to the puff. For example, the puff sensor 132 may be a pressure sensor. The puff sensor 132 may output a signal corresponding to internal pressure of the aerosol generating device. The internal pressure of the aerosol generating device 1 may correspond to pressure of the airflow path on which gas flows. The puff sensor 132 may be disposed to correspond to the airflow path on which gas flows, in the aerosol generating device 1.

The insertion detection sensor 133 may detect insertion and/or removal of the stick S. The insertion detection sensor 133 may detect signal changes relating to insertion and/or removal of the stick S. The insertion detection sensor 133 may be installed around an insertion space. The insertion detection sensor 133 may detect insertion and/or removal of the stick S according to changes in dielectric constants inside the insertion space. For example, the insertion detection sensor 133 may be an inductive sensor and/or a capacitance sensor.

The inductive sensor may include at least one coil. The coil of the inductive sensor may be disposed adjacent to the insertion space. For example, when a magnetic field changes around a coil through which a current flows, the characteristics of the current flowing through the coil may be changed according to the Faraday's law. The characteristics of the current flowing through the coil may include a frequency of an alternating current, a current value, a voltage value, an inductance value, an impedance value, etc.

The inductive sensor may output signals corresponding to the characteristics of the current flowing through the coil. For example, the inductive sensor may output signals corresponding to the inductance value of the coil.

The capacitance sensor may include a conductor. The conductor of the capacitance sensor may be disposed adjacent to the insertion space. The capacitance sensor may output a signal corresponding to an electromagnetic characteristic of the surroundings, for example, an electrostatic capacitance around the conductor. For example, when the stick S including a wrapper made of a metal material is inserted into the insertion space, the electromagnetic properties around the conductor may be changed by the wrapper of the stick S.

The reuse detection sensor 134 may detect whether the stick S is reused. The reuse detection sensor 134 may be a color sensor. The color sensor may detect a color of the stick S. The color sensor may detect a color of a portion of the wrapper surrounding the outside of the stick S. The color sensor may detect values for optical characteristics corresponding to the color of an object, based on light reflected by the object. For example, the optical characteristics may be a wavelength of the light. The color sensor may be implemented as a single component with the proximity sensor, or may be implemented as a separate component distinct from the proximity sensor.

A color of at least a portion of the wrapper that constitutes the stick S may be changed by aerosol. In case where the stick S is inserted into the insertion space, the reuse detection sensor 134 may be disposed to correspond to a location in which at least a portion of the wrapper of which color is changed by aerosol. For example, before the stick S is used by the user, the color of at least the portion of the wrapper may be a first color. In this case, as at least a portion of the wrapper is wet by aerosol generated by the aerosol generating device 1 while the aerosol is passing through the stick S, the color of the at least a portion of the wrapper may be changed to a second color. The color of the at least a portion of the wrapper may be maintained as the second color after being changed from the first color to the second color.

The cartridge detection sensor 135 may detect insertion and/or removal of the cartridge 19. The cartridge detection sensor 135 may be implemented by an inductance-based sensor, a capacitive sensor, a resistance sensor, a hall sensor (hall IC) using a hall effect, etc.

The cap detection sensor 136 may detect mounting and/or removal of a cap. When the cap is separated from the body 10, a portion of the cartridge 19 and the body 10 covered by the cap may be exposed to the outside. The cap detection sensor 136 may be implemented by a contact sensor, a hall sensor (hall IC), an optical sensor, etc.

The movement detection sensor 137 may detect a movement of the aerosol generating device. The movement detection sensor 137 may be implemented with at least one of an acceleration sensor and a gyro sensor.

The sensor 13 may further include at least one of a humidity sensor, a barometric pressure sensor, a magnetic sensor, a global positioning sensor (GPS), and a proximity sensor, in addition to the above-described sensors 131 through 137. Functions of the sensors would be instinctively understood by one of ordinary skill in the art in view of their names and thus detailed descriptions thereof will be omitted herein.

The output unit (output interface) 14 may output information about the state of the aerosol generating device 1 and may provide the information to the user. The output unit 14 may include at least one of a display 141, a haptic unit 142, and a sound output unit 143, but embodiments are not limited thereto. When the display 141 forms a layer structure together with a touch pad to construct a touch screen, the display 141 may be used as an input device as well as an output device.

The display 141 may visually provide information about the aerosol generating device 1 to the user. For example, the information about the aerosol generating device 1 may refer to various pieces of information, such as the charging/discharging state of the power source 11 of the aerosol generating device 1, a preheating state of the heater 18, an insertion/removal state of the stick S and/or the cartridge 19, a mounting/removal state of the cap, or a state in which use of the aerosol generating device 1 is limited (e.g., detection of an abnormal article), and the display 141 may output the information to the outside. For example, the display 141 may have a shape of a light-emitting diode (LED). For example, the display 141 may be a liquid crystal display (LCD), an organic light-emitting display (OLED) panel, or the like.

The haptic unit 142 may convert an electrical signal into a mechanical stimulus or electrical stimulus and may tactually provide information about the aerosol generating device 1 to the user. For example, when initial power is supplied to the cartridge heater 24 and/or the heater 18 for a set time, the haptic unit 142 may generate vibration corresponding to completion of initial preheating. The haptic unit 142 may include a motor, a piezoelectric element, and/or an electrical stimulation device.

The sound output unit 143 may acoustically provide the information about the aerosol generating device 1 to the user. For example, the sound output unit 143 may convert the electrical signal into a sound signal and may output the sound signal to the outside.

The power source (power supply) 11 may supply power used to operate the aerosol generating device 1. The power source 11 may supply power so that the cartridge heater 24 and/or the heater 18 may be heated. In addition, the power source 11 may supply power required for operations of the sensor 13, the output unit 14, the input unit 15, the communication unit 16, and the memory 17, which are other components provided in the aerosol generating device 1. The power source 11 may be a rechargeable battery or a disposable battery. For example, the power source 11 may be a lithium polymer (LiPoly) battery, but embodiments are not limited thereto.

Although not shown in FIG. 17, the aerosol generating device 1 may further include a power supply protection circuit. The power supply protection circuit may be electrically connected to the power source 11 and may include a switching element.

The power supply protection circuit may cut off an electric path for the power source 11 according to certain conditions. For example, when a voltage level of the power source 11 is greater than or equal to a first voltage corresponding to overcharging, the power supply protection circuit may cut off the electric path for the power source 11. For example, when a voltage level of the power source 11 is less than a second voltage corresponding to overdischarging, the power supply protection circuit may cut off the electric path for the power source 11.

The heater 18 may heat a medium or an aerosol generating material in the stick S by receiving power from the power source 11. Although not shown in FIG. 17, the aerosol generating device 1 may further include a power conversion circuit (e.g., a DC/DC converter) for converting power of the power source 11 to supply the converted power to the cartridge heater 24 and/or the heater 18. In addition, when the aerosol generating device 1 generates aerosol by using an induction heating method, the aerosol generating device 1 may further include a DC/AC converter that converts direct current power of the power source 11 into alternating current power.

The controller 12, the sensor 13, the output unit 14, the input unit 15, the communication unit 16, and the memory 17 may perform functions by receiving power from the power source 11. Although not shown in FIG. 17, the aerosol generating device 1 may further include a power conversion circuit for converting the power of the power source 11 to supply the converted power to components, for example, a low dropout (LDO) circuit or a voltage regulator circuit. Although not shown in FIG. 17, a noise filter may be provided between the power source 11 and the heater 18. The noise filter may be a low pass filter. The low pass filter may include at least one inductor and a capacitor. A cutoff frequency of the low pass filter may correspond to a frequency of a radio frequency switching current applied from the power source 11 to the heater 18. Radio frequency noise components may be prevented from being applied to the sensor 13, such as the insertion detection sensor 133, by the low pass filter.

According to an embodiment, the cartridge heater 24 and/or the heater 18 may be formed of an arbitrary proper electric resistance material. For example, the proper electric resistance material may be metal or metal alloy including titanium, zirconium, tantalum, platinum, nickel, cobalt, chromium, hafnium, niobium, molybdenum, tungsten, tin, gallium, manganese, iron, copper, stainless steel, nichrome, etc., but embodiments are not limited thereto. Also, the heater 18 may be implemented using a metal heating wire, a metal heating plate on which an electric conductive track is disposed, a ceramic heating body, or the like, but embodiments are not limited thereto.

According to another embodiment, the heater 18 may be a heater using an induction heating method. For example, the heater 18 may include a susceptor that generates heat by a magnetic field applied by the coil and heats the aerosol generating material.

The input unit (input interface) 15 may receive information input from the user or may output the information to the user. For example, the input unit 15 may be a touch panel. The touch panel may include at least one touch sensor that detects touch. For example, the touch sensor may include a capacitive touch sensor, a resistive touch sensor, a surface acoustic wave touch sensor, an infrared touch sensor, or the like, but embodiments are not limited thereto.

The display 141 and the touch panel may be implemented as one panel. For example, the touch panel may be inserted (on-cell type or in-cell type) into the display 141. For example, the touch panel may be added on (add-on type) the display panel.

The input unit 15 may include a button, a key pad, a dome switch, a jog wheel, a jog switch, or the like, but embodiments are not limited thereto.

The memory 17 is hardware for storing various kinds of data processed in the aerosol generating device 1, and may store pieces of data that have been processed and are to be processed by the controller 12. The memory 17 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. The memory 17 may store data about the operating time of the aerosol generating device 1, a maximum number of puffs, a current number of puffs, at least one temperature profile, and the user's smoking pattern.

The communication unit (communication interface, communicator) 16 may include at least one component for communication with other electronic devices. For example, the communication unit 16 may include at least one of a short-range wireless communication unit and a wireless communication unit.

Examples of the short-range wireless communication unit may include, but are not limited to, a Bluetooth communication unit, a Bluetooth Low Energy (BLE) communication unit, a near field communication (NFC) unit, a wireless local area network (WLAN) (e.g., Wi-Fi) communication unit, a ZigBee communication unit, an infrared Data Association (IrDA) communication unit, a Wi-Fi direct (WFD) communication unit, an ultra wideband (UWB) communication unit, and an Ant+ communication unit.

The wireless communication unit may include a cellular network communication unit, an Internet communication unit, a computer network (e.g., a LAN or a WAN) communication unit, or the like, but embodiments are not limited thereto.

Although not shown in FIG. 17, the aerosol generating device 1 may further include a connection interface, such as a universal serial bus (USB) interface, and may transmit/receive information by being connected to another external device through the connection interface, such as a USB interface, or may charge the power source 11.

The controller 12 may control overall operations of the aerosol generating device 1. According to an embodiment, the controller 12 may include at least one processor. The processor may be implemented by an array of a plurality of logic gates, or may be implemented by a combination of a general-use microprocessor and a memory in which a program executable by the general-use microprocessor is stored. It will also be understood by one of ordinary skill in the art to which the present embodiment pertains that the processor may be implemented by other types of hardware.

The controller 12 may control supplying of the power of the power source 11 to the heater 18, thereby controlling the temperature of the heater 18. The controller 12 may control the temperature of the cartridge heater 24 and/or the heater 18, based on the temperature of the cartridge heater 24 and/or the heater 18 sensed by the temperature sensor 131. The controller 12 may control power supplied to the cartridge heater 24 and/or the heater 18, based on the temperature of the cartridge heater 24 and/or the heater 18. For example, the controller 12 may determine a target temperature of the cartridge heater 24 and/or the heater 18, based on a temperature profile stored in the memory 17.

The aerosol generating device 1 may include a power supply circuit (not shown) electrically connected to the power source 11 between the power source 11 and the cartridge heater 24 and/or the heater 18. The power supply circuit may be electrically connected to the cartridge heater 24, the heater 18, or an induction coil 181. The power supply circuit may include at least one switching element. The switching element may be implemented by a bipolar junction transistor (BJT), a field effect transistor (FET), or the like. The controller 12 may control the power supply circuit.

The controller 12 may control switching of the switching element of the power supply circuit, thereby controlling the supply of power. The power supply circuit may be an inverter that converts direct current power output by the power source 11 into alternating current power. For example, the inverter may include a full-bridge circuit or half-bridge circuit including a plurality of switching elements.

The controller 12 may turn on the switching element so that power may be supplied from the power source 11 to the cartridge heater 24 and/or the heater 18. The controller 12 may turn off the switching element so that the supply of power to the cartridge heater 24 and/or the heater 18 may be cut off. The controller 12 may adjust a current supplied by the power source 11 by adjusting a frequency and/or duty ratio of a current pulse input to the switching element.

The controller 12 may control a voltage output by the power source 11 by controlling switching of the switching element of the power supply circuit. The power conversion circuit may convert the voltage output by the power source 11. For example, the power conversion circuit may include a Buck-converter that drops the voltage output by the power source 11. For example, the power conversion circuit may be implemented through a Buck-boost converter, a Zener diode, etc.

The controller 12 may adjust the level of the voltage output by the power conversion circuit by controlling an on/off operation of the switching element included in the power conversion circuit. When an on state of the switching element is continued, the level of the voltage output by the power conversion circuit may correspond to the level of the voltage output by the power source 11. A duty ratio with respect to the on/off operation of the switching element may correspond to a ratio of the voltage output by the power conversion circuit to the voltage output by the power source 11. As the duty ratio with respect to the on/off operation of the switching element is decreased, the level of the voltage output by the power conversion circuit may be reduced. The heater 18 may be heated based on the voltage output by the power conversion circuit.

The controller 12 may control power to be supplied to the heater 18, by using at least one method of a pulse width modulation (PWM) method and a proportional-integral-differential (PID) method.

For example, the controller 12 may control supply of a current pulse having a certain frequency and a duty ratio, by using the PWM method. The controller 12 may control power supplied to the heater 18 by adjusting the frequency and duty ratio of the current pulse.

For example, the controller 12 may determine a target temperature that is a target of control, based on the temperature profile. The controller 12 may control the power supplied to the heater 18 by using a PID method, which is a feedback control method using a difference value between the temperature of the heater 18 and the target temperature thereof, a value obtained by integrating the difference value according to the flow of time, and a value obtained by differentiating the difference value according to the flow of time.

The controller 12 may prevent the cartridge heater 24 and/or the heater 18 from being overheated. For example, the controller 12 may control an operation of the power conversion circuit so that the supply of the power to the cartridge heater 24 and/or the heater 18 is stopped, based on the temperature of the cartridge heater 24 and/or the heater 18 exceeding a preset limit temperature. For example, the controller 12 may reduce the amount of power supplied to the cartridge heater 24 and/or the heater 18, based on the temperature of the cartridge heater 24 and/or the heater 18 exceeding the preset limit temperature. For example, the controller 12 may determine that the aerosol generating material accommodated in the cartridge 19 is exhausted, based on the temperature of the cartridge heater 24 exceeding the limit temperature, and may cut off the supply of power to the cartridge heater 24.

The controller 12 may control charging/discharging of the power source 11. The controller 12 may check the temperature of the power source 11, based on an output signal of the temperature sensor 131.

When a power wire is connected to a battery terminal of the aerosol generating device 1, the controller 12 may check whether the temperature of the power source 11 is greater than or equal to a first limit temperature that is a basis for blocking charging of the power source 11. When the temperature of the power source 11 is less than the first limit temperature, the controller 12 may control the power source 11 to be charged, based on a preset charging current. When the temperature of the power source 11 is equal to or greater than the first limit temperature, the controller 12 may block charging of the power source 11.

When power of the aerosol generating device 1 is in an on state, the controller 12 may check whether the temperature of the power source 11 is greater than or equal to a second limit temperature that is a basis for cutting off discharging of the power source 11. When the temperature of the power source 11 is less than the second limit temperature, the controller 12 may control the power stored in the power source 11 to be used. When the temperature of the power source 11 is greater than or equal to the second limit temperature, the controller 12 may stop using the power stored in the power source 11.

The controller 12 may calculate the remaining capacity of the power stored in the power source 11. For example, the controller 12 may calculate the remaining capacity of the power source 11, based on a voltage and/or current sensing value of the power source 11.

The controller 12 may determine whether the stick S is inserted into the insertion space, through the insertion detection sensor 133. The controller 12 may determine that the stick S is inserted, based on an output signal of the insertion detection sensor 133. When it is determined that the stick S is inserted into the insertion space, the controller 12 may control power to be supplied to the cartridge heater 24 and/or the heater 18. For example, the controller 12 may supply power to the cartridge heater 24 and/or the heater 18, based on the temperature profile stored in the memory 17.

The controller 12 may determine whether the stick S is removed from the insertion space. For example, the controller 12 may determine whether the stick S is removed from the insertion space, through the insertion detection sensor 133. For example, when the temperature of the heater 18 is greater than or equal to the limit temperature or when a temperature change slope of the heater 18 is equal to or greater than a set slope, the controller 12 may determine that the stick S is removed from the insertion space. When it is determined that the stick S has been removed from the insertion space, the controller 12 may block supply of power to the cartridge heater 24 and/or the heater 18.

The controller 12 may control a power supply time and/or a power supply amount for the heater 18 according to the state of the stick S detected by the sensor 13. The controller 12 may check a level range in which the level of a signal of a capacitance sensor is included, based on a lookup table. The controller 12 may check a moisture amount for the stick S according to the checked level range.

When the stick S is in an overwatering state, the controller 12 may control the power supply time for the heater 18 to thereby increase the preheating time of the stick S rather than when the stick S is in a general state.

The controller 12 may determine whether the stick S inserted into the insertion space is reused, through the reuse detection sensor 134. For example, the controller 12 may compare a sensing value of a signal of the reuse detection sensor with a first reference range in which a first color is included, and may determine that the stick S is not used when the sensing value is included in the first reference range. For example, the controller 12 may compare the sensing value of the signal of the reuse detection sensor with a second reference range in which a second color is included, and may determine that the stick S is used when the sensing value is included in the second reference range. When it is determined that the stick S is used, the controller 12 may block supply of power to the cartridge heater 24 and/or the heater 18.

The controller 12 may determine whether the cartridge 19 is combined and/or removed, through the cartridge detection sensor 135. For example, the controller 12 may determine whether the cartridge 19 is combined or removed, based on the sensing value of a signal of the cartridge detection sensor.

The controller 12 may determine whether the aerosol generating material of the cartridge 19 is exhausted. For example, the controller 12 may preheat the cartridge heater 24 and/or the heater 18 by applying power, may determine whether the temperature of the cartridge heater 24 exceeds the limit temperature in a preheating section, and, when the temperature of the cartridge heater 24 exceeds the limit temperature, may determine that the aerosol generating material of the cartridge 19 is exhausted. When it is determined that the aerosol generating material of the cartridge 19 is exhausted, the controller 12 may cut off the supply of power to the cartridge heater 24 and/or the heater 18.

The controller 12 may determine whether use of the cartridge 19 is possible. For example, the controller 12 may determine that the use of the cartridge 19 is not possible if a current puff frequency is greater than or equal to a maximum puff frequency set in the cartridge 19, based on data stored in the memory 17. For example, when a total time period during which the heater 24 is heated is greater than or equal to a preset maximum time period or a total amount of power supplied to the cartridge heater 24 is greater than or equal to a preset maximum power amount, the controller 12 may determine that the use of the cartridge 19 is not possible.

The controller 12 may perform determination on the user's inhaling through the puff sensor 132. For example, the controller 12 may determine whether a puff occurs, based on a sensing value of a signal of the puff sensor. For example, the controller 12 may determine the intensity of the puff, based on the sensing value of the signal of the puff sensor 132. When the puff frequency reaches the preset maximum puff frequency or puffs are not sensed for a preset time period or more, the controller 12 may cut off the supply of power to the cartridge heater 24 and/or the heater 18.

The controller 12 may determine whether the cap is combined and/or removed, through the cap detection sensor 136. For example, the controller 12 may determine whether the cap is combined or removed, based on a sensing value of a signal of the cartridge detection sensor.

The controller 12 may control the output unit 14, based on a result of the sensing performed by the sensor 13 For example, when the number of puffs counted by the puff sensor 132 reaches a preset number, the controller 12 may notify the user in advance that the aerosol generating device 1 is ended soon, through at least one of the display 141, the haptic unit 142, and the sound output unit 143. For example, the controller 12 may notify the user through the output unit 14, based on a determination that the stick S is not present in the insertion space. For example, the controller 12 may notify the user through the output unit 14, based on a determination that the cartridge 19 and/or the cap is not mounted. For example, the controller 12 may transmit information about the temperature of the cartridge heater 24 and/or the heater 18 to the user through the output unit 14.

The controller 12 may store and update a history of an event occurred in the memory 17, based on certain event occurrence. The event may include insertion detection of the stick S, heating start of the stick S, puff detection, puff end, overheat detection of the cartridge heater 24 and/or the heater 18, detection of overvoltage application to the cartridge heater 24 and/or the heater 18, heating end of the stick S, an operation such as power on/off of the aerosol generating device 1, charging start of the power source 11, detection of overcharging of the power source 11, and charging end of the power source 11, which are performed by the aerosol generating device 1. The history of the event may include, for example, a date and time of the event, log data corresponding to the event. For example, when a predetermined event is insertion detection of the stick S, log data corresponding to the event may include data for the sensing value, etc. of the insertion detection sensor 133. For example, when the predetermined event is overheating detection of the cartridge heater 24 and/or the heater 18, the log data corresponding to the event may include data about, for example, the temperature of the cartridge heater 24 and/or heater 18, the voltage applied to the cartridge heater 24 and/or the heater 18, and a current flowing through the cartridge heater 24 and/or the heater 18.

The controller 12 may control a communication link to be formed with an external device, such as the user's mobile terminal. When receiving data on authentication from an external device through the communication link, the controller 12 may remove limitation of the use of at least one function of the aerosol generating device 1. The data on authentication may include data indicating completion of user authentication with respect to a user corresponding to the external device. The user may perform user authentication through the external device. The external device may determine whether user data is valid, based on the user's birthday and a unique number representing the user, and may receive data about use authority of the aerosol generating device 1 from an external server. The external device may transmit data indicating the completion of the user authentication to the aerosol generating device 1, based on the data about the use authority. When the user authentication is completed, the controller 12 may remove limitation of the use of the at least one function of the aerosol generating device 1. For example, when the user authentication is completed, the controller 12 may_remove the limitation of the use of a heating function of supplying power to the heater 18.

The controller 12 may transmit data on the state of the aerosol generating device 1 to the external device through the communication link formed with the external device. Based on the received state data, the external device may output the remaining capacity, the operation mode, etc. of the power source 11 of the aerosol generating device 1 through a display of the external device.

The external device may transmit a position search request to the aerosol generating device 1, based on an input of starting a position search of the aerosol generating device 1. When receiving a position search request from the external device, the controller 12 may control at least one of output devices to perform an operation corresponding to a position search, based on the received position search request. For example, the haptic unit 142 may generate vibration in response to the position search request. For example, in response to the position search request, the display 141 may output an object that corresponds to position search and search end.

The controller 12 may control firmware update to be performed, when receiving firmware data from the external device. The external device may check a current version of the firmware of the aerosol generating device 1 and determine whether a new version of the firmware is present. When receiving an input of requesting for firmware download, the external device may receive the new version of the firmware data and transmit the new version of the firmware data to the aerosol generating device 1. As the controller 12 receives the new version of the firmware data, the controller 12 may control the firmware update of the aerosol generating device 1 to be performed.

The controller 12 may transmit data on a sensing value of the at least one sensor 13 to an external server (not shown) through the communication unit 16, and may receive and store a learning model generated by learning sensing values from a server through machine learning, such as deep learning. The controller 12 may perform, for example, an operation of determining the user's inhaling pattern and an operation of generating a temperature profile, by using the learning model received from the server. The controller 12 may store, for example, sensing value data of the at least one sensor 13 and data for training an artificial neural network (ANN) in the memory 17. For example, the memory 17 may store a database for each component provided in the aerosol generating device 1, a weight that forms an ANN structure, and biases, which are for training the ANN. The controller 12 may learn data on a sensing value of at least one sensor 13, the user's inhaling pattern, the temperature profile, etc. stored in the memory 17, and may generate at least one learning model used for, for example, determination of the user's inhaling pattern, generation of the temperature profile.

Certain embodiments or other embodiments of the present disclosure described above are not exclusive or distinct from each other. The certain embodiments or other embodiments of the present disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictedly but should be considered illustrative in all aspects. The scope of the present disclosure should be determined by a rational interpretation of the attached claims, and all changes within the equivalent scope of the present disclosure are included in the scope of the present disclosure.

According to an aerosol generating device according to embodiments, precise sensing may be possible without malfunction of an inductive sensor or a controller, and the reliability of the controller with respect to a result of determination may be improved.

Effects of the present disclosure are not limited to the above effects, and effects that are not mentioned could be clearly understood by one of ordinary skill in the art from the present specification and the attached drawings.

What is claimed is:

1. An aerosol generating device comprising:
a body comprising an insertion space to accommodate an aerosol generating article;
a heater configured to heat the aerosol generating article accommodated in the insertion space;
an inductive sensor configured to generate a sensing value according to a distance to a magnetic object; and
a controller electrically connected to the inductive sensor and configured to determine a degree of proximity of the magnetic object to the body by comparing the sensing value with a reference value as a reference for determination,
wherein the controller is further configured to calibrate the reference value based on the sensing value such that the reference value maintains a certain difference from the sensing value.

2. The aerosol generating device of claim 1, wherein, when the sensing value changes and the changed sensing value does not correspond to a certain range, the controller is further configured to calibrate the reference value based on the changed sensing value.

3. The aerosol generating device of claim 1, further comprising a cap separately coupled to an end of the body,
wherein the inductive sensor is further configured to generate the sensing value according to a distance to the cap comprising a magnetic object, and
the controller is further configured to determine, based on the reference value and the sensing value, whether or not the cap is coupled to the body.

4. The aerosol generating device of claim 1, wherein the inductive sensor is further configured to generate the sensing value according to a distance to the aerosol generating article comprising a magnetic object, and
the controller is further configured to determine, based on the reference value and the sensing value, whether or not the aerosol generating article is accommodated in the insertion space.

5. The aerosol generating device of claim 1, wherein the controller is further configured to calibrate the reference value based on the sensing value at a certain time point.

6. The aerosol generating device of claim 1, wherein the controller is further configured to calibrate the reference value according to a certain cycle.

7. The aerosol generating device of claim 6, wherein, when a certain time point for calibrating the reference value according to the certain cycle is reached, the controller is further configured to calibrate the reference value according to a change of the sensing value during one previous cycle with respect to the certain time point.

8. The aerosol generating device of claim 6, wherein, until a certain time period passes after the heater starts heating, the controller is further configured to maintain the reference value even when the certain time point for calibrating the reference value according to the certain cycle is reached.

9. The aerosol generating device of claim 1, wherein the controller is further configured to calibrate the reference value after a certain time period passes after the heater starts heating.

10. The aerosol generating device of claim 1, further comprising a temperature sensor configured to sense a temperature of the heater,
wherein the controller is further configured to determine the temperature of the heater according to a signal generated by the temperature sensor and calibrate the reference value when the temperature of the heater reaches a certain temperature.

11. An aerosol generating device comprising:
a body comprising an insertion space to accommodate an aerosol generating article;
a heater configured to heat the aerosol generating article accommodated in the insertion space;
an inductive sensor configured to generate a sensing value according to a distance to a magnetic object; and
a controller electrically connected to the inductive sensor and configured to determine a degree of proximity of the magnetic object to the body based on the sensing value,
wherein the controller is further configured to calibrate the sensing value to become equal to a preset initial value.

12. The aerosol generating device of claim 11, wherein the controller is further configured to calibrate the sensing value after a certain time period passes after the heater starts heating.

13. The aerosol generating device of claim 11, wherein the controller is further configured to calibrate the sensing value according to a certain cycle, and
wherein, until a certain time period passes after the heater starts heating, the controller is further configured to maintain the sensing value even when a certain time point for calibrating the sensing value according to the certain cycle is reached.

14. The aerosol generating device of claim 11, further comprising a temperature sensor configured to sense a temperature of the heater,
wherein the controller is further configured to determine the temperature of the heater according to a signal generated by the temperature sensor and calibrate the sensing value when the temperature of the heater reaches a certain temperature.

15. The aerosol generating device of claim 14, wherein the controller is further configured to set the sensing value as the preset initial value when the temperature of the heater reaches the certain temperature.
